(19) United States
(12) Patent Application Publication
(10) Pub. No.: US 2008/0258353 A1
(43) Pub. Date: Oct. 23, 2008

(54) METHODS AND SYSTEMS FOR FORMING MULTILAYER ARTICLES

(76) Inventors: Gerald Hutchinson, Coto de Caza, CA (US); Prasad Joshi, Brookfield, CT (US); Said K. Farha, Pleasantville, NY (US); Heinrich Feichtinger, Hinteregg (CH)

Correspondence Address: KNOBBE MARTENS OLSON & BEAR LLP, 2040 MAIN STREET, FOURTEENTH FLOOR, IRVINE, CA, 92614, US

(21) Appl. No.: 12/106,189

(22) Filed: Apr. 18, 2008

Related U.S. Application Data
(60) Provisional application No. 60/912,675, filed on Apr. 18, 2007.

(51) Int. Cl. B29C 45/06

(52) U.S. Cl. 264/483; 425/523; 425/540; 264/513

(57) ABSTRACT

Disclosed is a mold system which comprises a cube configured to rotate about an axis, a first cavity platen comprising at least one first cavity section, a second cavity platen comprising at least one second cavity section, a fluid channel being disposed within at least one of the mandrels and a hydraulic connection member configured to connect at least one of the fluid channels to an inlet and or outlet positioned outside the cube. The cube comprises at least two sides, each side comprising at least one mandrel. The hydraulic connection member is configured to deliver a volume cooling fluid from or to the fluid channels while the cube is rotating.

### RELATED APPLICATIONS

This application claims the priority benefit under 35 U.S.C. § 119(e) of U.S. Provisional Application No. 60/912,675, filed Apr. 18, 2007, which is hereby incorporated by reference in its entirety.

### BACKGROUND OF THE INVENTIONS

1. Field of the Inventions

This application relates to molds for producing preforms and other articles. More specifically, this application relates to methods and systems for controlling mold temperatures in the manufacturing of multi-layer preforms.

2. Description of the Related Art

The use of plastic containers as a replacement for glass or metal containers in the packaging of beverages has become increasingly popular. The advantages of plastic packaging include lighter weight, decreased breakage as compared to glass, and potentially lower costs. The most common plastic used in making beverage containers today is PET. Virgin PET has been approved by the FDA for use in contact with foodstuffs. Containers made of PET are transparent, thin-walled, lightweight, and have the ability to maintain their shape by withstanding the force exerted on the walls of the container by pressurized contents, such as carbonated beverages. PET resins are also fairly inexpensive and easy to process.

Most PET bottles are made by a process that includes the blow-molding of plastic preforms, which have been made by processes including injection and compression molding. For example, in order to increase the through-put of an injection molding machine, and thereby decrease the cost of each individual preform, it is desirable to reduce the cycle time for each injection and cooling cycle. However, the injected preform must cool sufficiently to maintain its molded dimensions before it is removed from the injection mold. Therefore, it would be desirable to utilize a cooling system that can rapidly cool the injected preform. Typically, the temperature of the mold is controlled by pumping cooled water through passages which are within the mold. The temperature of the mold is thus controlled by the temperature of the water flowing through the water passages. The water typically flows continuously throughout the molding operation and may cause condensation to form on the mold. For example, when the mold is cooled by utilizing chilled water, the moisture in the air surrounding the mold can condense, thereby forming condensation on the molding surfaces. The condensation may interfere with the molding operation by reducing preform production and decreasing preform quality. As a result, the potential of mold cooling systems has not been realized.

### SUMMARY OF THE INVENTIONS

According to some embodiments, an injection molding system for producing multi-layer (e.g., two-layer, three-layer, etc.) preforms includes a first cavity platen comprising a plurality of first cavity sections and a second cavity platen comprising a plurality of second cavity sections. The system also includes a core portion having at least two core surfaces. A core surface can comprise a plurality of cores or mandrels that are configured to selectively mate with the first cavity sections to define a plurality of first mold cavities therebetween. The first mold cavities can be configured to receive a thermoplastic material (e.g., PET) to produce a first layer of a preform. The cores can be further configured to mate with the second cavity sections to define a plurality of second mold cavities therebetween. The second mold cavities can be configured to receive a thermoplastic material (e.g., RPET, PET, etc.) to produce a second layer of a preform. The second layer being disposed along an exterior portion of the first layer. In some embodiments, the core portion is configured to rotate between various positions so the cores sequentially align and mate with the first cavity sections and the second cavity sections. In some arrangements, the cores from a first core surface mate with the first cavity sections generally at a same time that the cores from a second core surface mate with the second cavity sections.

In some embodiments, the core portion comprises internal channels adapted to circulate a cooling fluid (e.g., water, refrigerants, cryogenic or non-cryogenic fluids, other gases or liquids, etc.) within an inner portion of one or more cores. The internal channels can be configured so that a cooling effect produced at the cores of the first core surface can be selectively varied from a cooling effect produced at the cores of the second core surface. In one embodiment, the cooling fluids are configured to continue flowing through the internal channels when the core portion is being rotated. In some arrangements, the internal channels of the core portion are in fluid communication with a rotary union or other specialty fitting or device.

In some embodiments, the core portion generally comprises a cube shape, with the first core surface of the core portion being generally opposite of the second core surface. In some embodiments, a first core surface is generally positioned 180 degrees opposite a second core surface. In some embodiments, four surfaces of the core portion comprise cores or mandrels. In one embodiment, the core portion comprises cores on four adjacent core surfaces. In some arrangements, the core portion includes four core surfaces, each of said four core surfaces comprising a plurality of cores. In some embodiments, the core portion is configured to be selectively rotated in 90, 180 or any other degree increments relative to the cavity sections, so that cores along the four surfaces of the core portion can be sequentially moved between different molding, treatment (e.g., surface treatment, cooling, etc.), overmolding, ejection or other removal and/or other steps or stations.

According to some embodiments, the mold system further includes a treatment portion, area or step located at an intermediate treatment location. The treatment portion can be adapted to selectively surface treat the preforms. The core portion can be configured to move to the intermediate treatment location before the cores mate with the second, overmolding cavity sections. In some embodiments, surface treatment occurring at the intermediate treatment location comprises flame treatment, corona treatment, ionized air treatment, plasma arc treatment, surface abrasion, cooling and/or any other treatment. In some embodiments, following the first molding step or station, cores having preforms with an initial substrate layer (e.g., PET) positioned thereon are rotated to a treatment station to receive a desired surface treatment before being rotated to the overmolding station. In one embodiment, the system further comprises a robot configured to remove the multi-layer preforms from a desired set of cores (e.g., following overmolding). In other embodiments, multilayer preforms are removed by an ejector system or any other removal method or device. In other embodiments, one or more cores, first cavity sections, second cavity sections and/or any other portions of the mold system comprise a high heat transfer material.

According to some embodiments, the cavity sections and/or the cores comprise cooling channels configured to receive one or more types of cooling fluids (e.g., water, refrigerants, cryogenic fluids, non-cryogenic fluids, other liquids or gases, etc.). The cooling channels can comprise a pressure reducing valve or element to reduce the pressure of the fluid flowing therethrough to effectively change the temperature of the fluid. In other arrangements, one or more adjacent mating surfaces of the cavity sections and/or the cores comprise hardened materials configured to resist the wear and impact resulting from contact during a production cycle. In some embodiments, the robot or other mechanical device that removes the preforms or other molded items can be configured to retain the preforms or other molded items therein for additional cooling. In one embodiment, a grasping portion of the robot comprises cooling channels. Once removed from the core portion, multilayer preforms can be placed on a conveyor belt or other receptacle. In some embodiments, preforms are dip coated with one or more barrier materials before being blow molded into a desired shape.

In some embodiments, a method of producing multi-layer preforms includes providing an injection mold system. The system can include a plurality of first cavity sections, a plurality of second cavity sections and a core portion having a first core surface and a second core surface. Each of the first and second core surfaces can include a plurality of cores. Further, the core portion can be configured to rotate so the cores selectively align and mate with the first cavity sections and the second cavity sections. In some embodiments, the cores are configured to mate with the first cavity sections to define a plurality of first mold cavities therebetween. The cores can be further configured to mate with the second cavity sections to define a plurality of second mold cavities therebetween. The method further includes rotating the core portion so the cores of the first core surface align with the first cavity sections and mating the cores of the first surface with the first cavity sections to define a plurality of first mold cavities therebetween.

In some embodiments, the method additionally includes injecting a first thermoplastic material or substrate (e.g., PET, another polyester, etc.) into the first mold cavities to partially form a plurality of preforms and cooling the core portion and/or the first mold cavities before moving the first cavity sections away from the core portion so that the preforms remain on the cores of the first core surface. The method can further comprise indexing, rotating or otherwise moving the core portion (e.g., so the cores of the first core surface align with the second cavity sections and mating the cores of the first core surface with the second cavity sections) to define a plurality of second mold cavities therebetween. Further, the method includes injecting a second thermoplastic material (e.g., RPET, PET, other recycled materials, etc.) into the second mold cavities along an exterior of the first thermoplastic material of the preforms, removing the preforms from the cores of the first core surface and rotating the core portion so the cores of the first core surface realign with the first cavity sections. In some arrangements, the cores of the second core surface are configured to align and mate with the second cavity sections to receive the second thermoplastic material or thereon generally at the same time when the cores of the first core surface are aligned with and mated with the first cavity sections to receive the first thermoplastic material.

According to some embodiments, the method additionally includes surface treating the preforms prior to injecting the second thermoplastic material into the second mold cavities. In some embodiments, surface treating the preforms comprises rotating the core portion to an intermediate position generally located between the first cavity sections and the second cavity sections. In other embodiments, surface treating the preforms comprises flame treatment, corona treatment, ionized air treatment, plasma arc treatment, surface abrasion, cooling and/or the like. In one embodiment, removing the preforms from the cores includes moving a robot to align with and removably engage the preforms.

In some embodiments, removing the preforms from the cores includes rotating the core portion to an ejection station before rotating the core portion so the cores realign with the first cavity sections. In other embodiments, the core portion comprises internal channels adapted to circulate a cooling fluid within an inner portion of each core. The internal channels can be configured so that a cooling effect produced at the cores of the first core surface can be selectively varied from a cooling effect produced at the cores of the second core surface. In other arrangements, cooling fluids are configured to continue flowing through the internal channels when the core portion is being rotated. In still other embodiments, the internal channels of the core portion are in fluid communication with a rotary union and/or another specialty fitting or device.

According to other embodiments, a method of producing multi-layer plastic objects includes providing a mold system. The mold system can include a plurality of first cavity sections, a plurality of second cavity sections and a core portion having at a first core surface and a second core surface. The first and second core surfaces can include a plurality of cores. In some embodiments, the core portion is configured to be indexed, rotated or otherwise moved between different positions, allowing the cores to sequentially mate with the first cavity sections and the second cavity sections. In one embodiment, the core portion is adapted to be rotated in 90, 180 or any other degree increments.

The method further includes indexing, rotating or otherwise moving the core portion to a first position wherein the cores of the first core surface mate with the first cavity sections to define a plurality of first mold cavities therebetween, and wherein the cores of the second core surface mate with the second cavity sections to define a plurality of second mold cavities therebetween. In some embodiments, the method additionally comprises injecting a first moldable material within the first mold cavities to form a first layer of multi-layer plastic objects, and generally simultaneously injecting a second moldable material within the second mold cavities to form a second, outer layer on the plastic objects. Further, the method can include removing the plastic objects from the cores of the second core surface and indexing the core portion to a second position wherein the cores of the first core surface mate with the second cavity sections and the cores of the second core surface mate with the first cavity sections. In addition, the method comprises injecting a first moldable material along the outside of the cores of the second core surface, and generally simultaneously injecting a second moldable material along the outside of the cores of the first core surface to produce a plurality of multi-layer plastic objects thereon.

In some embodiments, the method further includes removing the plastic objects from the cores of the first core surface and repeating the process by indexing the core portion to the first position so that the cores of the first core surface re-mate with the first cavity sections and the cores of the second core surface re-mate with the second cavity sections. In some embodiments, the method further includes surface treating the plastic objects prior to injecting the second moldable material thereon. In other arrangements, surface treating comprises indexing, rotating or otherwise moving the core portion to a first intermediate position, which is generally situated between the first and second positions. In some arrangements, surface treating comprises flame treatment, corona treatment, ionized air treatment, plasma arc treatment, surface abrasion, cooling and/or the like.

In other arrangements, the mold system further comprises a robot having a grasping portion, such that removing the multi-layer objects from the cores includes aligning the grasping portion of the robot with the cores to engage and removably retain the multi-layer objects molded thereon. In other embodiments, removing the removing the plastic objects from the cores comprises indexing the core portion to an ejection location. In yet other arrangements, the core portion comprises internal channels adapted to circulate a cooling fluid within an inner portion of each core, the internal channels being configured so that a cooling effect produced at the cores of the first core surface can be selectively varied from a cooling effect produced at the cores of the second core surface. In one embodiment, the cooling fluids are configured to continue flowing through the internal channels when the core portion is being indexed. In some embodiments, this can be accomplished, at least in part, using a rotary union and/or other specialty fittings.

According to some embodiments, a mold includes a plurality of first cavity sections, a plurality of second cavity sections and a core portion having a plurality of cores on at least a first core surface and a second core surface. The core portion can be configured to rotate or otherwise move so the cores on a first core surface selectively engage the first cavity sections or the second cavity sections. In one embodiment, the core portion comprises internal channels adapted to circulate a cooling fluid within an inner portion of each core. The internal channels can be configured so that a cooling effect produced at the cores of the first core surface can be selectively varied from a cooling effect produced at the cores of the second core surface.

In some embodiments, cooling fluids are configured to continue flowing through the internal channels when the core portion is being rotated. In some arrangements, the internal channels of the core portion are in fluid communication with a rotary union and/or other special fitting or device. In one embodiment, internal channels within an inner portion of the cores positioned along the first core surface are in fluid communication with a first fluid source. The internal channels within an inner portion of the cores positioned along the second core surface are in fluid communication with a second fluid source. In some embodiments, the cores, the first cavity sections, the second cavity sections and/or any other portion of the mold includes a high heat transfer material.

According to some embodiments, an injection molding system includes an indexing cube having a first surface and second surface, the first surface being positioned generally opposite of the second surface. Each of the first surface and the second surface comprises a plurality of mandrels or cores. The injection molding system further includes a first mold cavity section configured to mate with the mandrels or cores to form a preform having a first thermoplastic layer (e.g., PET, other polyester, etc.), which includes an exterior surface. The system additionally includes a second mold cavity section configured to mate with the mandrels to form a second thermoplastic layer (e.g., RPET, PET, etc.) on the preform. In some embodiments, the second thermoplastic layer is directly adhered to the exterior surface of the first thermoplastic layer. In some embodiments, the indexing cube comprises at least cooling channel configured to provide a cooling fluid to the mandrels or cores. Further, the indexing cube is configured to rotate between a first position and a second position to permit the mandrels to selectively mate with the first mold cavity section and the second mold cavity section.

In some embodiments, the injection molding system further includes a robot configured to remove the preform from the mandrels. In one embodiment, the robot includes a grasping portion configured to engage and remove the preforms from the mandrels. In other arrangements, the grasping portion comprises at least one cooling channel, the cooling channel of the grasping portion allowing the preforms removed from the mandrels to be additionally cooled. In still other embodiments, the indexing cube comprises at least one fluid channel, the fluid channel being configured to deliver cooling fluids to the mandrels, wherein the fluid channel is in fluid communication with a cooling fluid source using a rotary union.

In some embodiments, the injection molding system comprises one or more intermediate treatment or conditioning steps. In one embodiment, such a step includes surface treatment such as flame treatment, corona treatment, ionized air treatment, plasma air treatment, plasma arc treatment and/or the like. In other embodiments, the cores or mandrels, the cavity sections and/or one or more other portions of the injection molding system include a high heat transfer material, such as AMPCOLOY® alloys, alloys comprising copper and beryllium and/or the like.

In accordance with some embodiments, a mold system comprises a cube configured to rotate about an axis, a first cavity platen comprising at least one first cavity section, a second cavity platen comprising at least one second cavity section, a fluid channel being disposed within at least one of the mandrels and a hydraulic connection member configured to connect at least one of the fluid channels to an inlet and or outlet positioned outside the cube. In some embodiments, the cube comprises at least two sides, each side comprising at least one mandrel. The hydraulic connection member is configured to deliver a volume cooling fluid from or to the fluid channels while the cube is rotating.

In some embodiments, the hydraulic connection member is a rotary union. In other embodiments, at least one of the mandrels comprises a high heat transfer material. In yet other embodiments, at least one of the fluid channels comprises a valve.

### BRIEF DESCRIPTION OF THE DRAWINGS

FIG. 1 is a preform as is used as a starting material for making a molded container;

FIG. 2 is a cross-section of the monolayer preform of FIG. 1;

FIG. 3 is a cross-section of a multilayer preform;

FIG. 4 is a cross-section of another embodiment of a multilayer preform;

FIG. 5 is a three-layer embodiment of a preform;

FIG. 6 is a cross-section of a preform in the cavity of a blow-molding apparatus of a type that may be used to make a container;

FIG. 6A is a cross-section of another embodiment of a blow-molding apparatus;

FIG. 7 is a side view of one embodiment of a container;

FIG. 8 is a schematic illustration of a temperature control system;

FIG. 9 is a schematic illustration of a temperature control system;

FIG. 10 is a cross-section of an injection mold of a type that may be used to make a preferred multilayer preform;

FIG. 11 is a cross-section of the mold of FIG. 10 taken along lines 11-11;

FIG. 12 is a cross-sectional view of a cavity section of a mold according to one embodiment;

FIG. 13 is another cross-sectional view of the cavity section of FIG. 12;

FIG. 14 is a cross-section of an enhanced injection mold core having a high heat transfer base end portion;

FIG. 15 is a cross-section of an injection mold utilizing a combination of hardened material components, high heat transfer material components and fluid channels;

FIGS. 16 and 17 are two halves of a molding apparatus to make multi-layer preforms;

FIGS. 18 and 19 are two halves of a molding apparatus to make forty-eight multi-layer preforms;

FIG. 20 is a perspective view of a schematic of a mold with cores partially located within the molding cavities;

FIG. 21 is a perspective view of a mold with cores fully withdrawn from the molding cavities, prior to rotation;

FIG. 22 is a cross-sectional view of a portion of a mold for molding articles;

FIG. 23 is a cross-sectional view of a heat transfer member of the mold of FIG. 22 taken along a line 23-23;

FIG. 24 illustrates an elevation view of an injection molding machine configured to produce multilayer preforms according to one embodiment;

FIG. 24A illustrates an elevation view of an injection molding machine configured to produce multilayer preforms according to another embodiment;

FIG. 25 schematically illustrates an embodiment of a rotating cube comprising mandrels on four of its sides;

FIG. 26 schematically illustrates a cube comprising a rotary union and a cooling fluid distribution system in accordance with one embodiment; and

FIG. 27 schematically illustrates a cube comprising a rotary union and a cooling fluid distribution system in accordance with another embodiment.

### DETAILED DESCRIPTION OF THE PREFERRED EMBODIMENT

All patents and publications mentioned herein are hereby incorporated by reference in their entireties. Except as further described herein, certain embodiments, features, systems, devices, materials, methods and techniques described herein may, in some embodiments, be similar to any one or more of the embodiments, features, systems, devices, materials, methods and techniques described in U.S. Pat. Nos. 6,109,006; 6,808,820; 6,528,546; 6,312,641; 6,391,408; 6,352,426; 6,676,883; 7,261,551; 7,303,387; U.S. patent application Ser. No. 09/745,013 (U.S. Publication No. 2002-0100566); Ser. No. 10/168,496 (U.S. Publication No. 2003-0220036); Ser. No. 09/844,820 (U.S. Publication No. 2003-0031814); 10/090,471 (U.S. Publication No. 2003-0012904); Ser. No. 10/395,899 (U.S. Publication No. 2004-0013833); Ser. No. 10/614,731 (U.S. Publication No. 2004-0071885); Ser. No. 10/705,748 (U.S. Publication No. 2004-0151937); Ser. No. 11/108,342 (U.S. Publication No. 2006-0065992); Ser. No. 11/108,345 (U.S. Publication No. 2006-0073294); Ser. No. 11/108,607 (U.S. Publication No. 2006-0073298); Ser. No. 11/512,002 (U.S. Publication No. 2007-0108668); Ser. No. 11/546,654 (U.S. Publication No. 2007-0087131); U.S. provisional application 60/563,021, filed Apr. 16, 2004; U.S. provisional application 60/575,231, filed May 28, 2004; U.S. provisional application 60/586,399, filed Jul. 7, 2004; U.S. provisional application 60/620,160, filed Oct. 18, 2004; U.S. provisional application 60/621,511, filed Oct. 22, 2004; and U.S. provisional application 60/643,008, filed Jan. 11, 2005, all of which are hereby incorporated by reference herein in their entireties. In addition, the embodiments, features, systems, devices, materials, methods and techniques described herein may, in certain embodiments, be applied to or used in connection with any one or more of the embodiments, features, systems, devices, materials, methods and techniques disclosed in the above-mentioned patents and applications.

### A. Detailed Description of Some Preferred Materials

1. General Description of Preferred Materials

The preforms, containers manufactured from preforms and/or other articles disclosed herein can comprise one or more different types of thermoplastic materials, such as polyethylene terephthalate (PET). However, the preforms and other molded items can comprise one or more other thermoplastics. In one embodiment, PET is used as the polyester substrate. As used herein, “PET” includes, but is not limited to, modified PET as well as PET blended with other materials, such as IPA.

As used herein, the term “substrate” is a broad term used in its ordinary sense and includes embodiments wherein “substrate” refers to the material used to form the first or innermost layer of a preform. Other suitable substrates for preforms, containers and/or other moldable items include, but are not limited to, various polymers such as polyesters (PET, PEN, PETG), polyolefins (PP and PE), polyamides (Nylon 6, Nylon 66), polycarbonates, polylactic acid (PLA), acrylics, polystyrenes, epoxies, grafted polymers, and copolymers or blends of any of the foregoing. In certain embodiments substrate materials may be virgin, pre-consumer, post-consumer, regrind, recycled, and/or combinations thereof.

One suitable coating or overmolding layer for a preform is RPET. As used herein, the term “RPET” is a broad term and refers, without limitation, to virgin, pre-consumer, post-consumer, regrind and/or recycled PET. In some embodiments, materials used in coating or other overmolding layers can include, but are not limited to, PET, RPET, other virgin and/or non-virgin polyesters, other recycled materials or combinations thereof. One or more layers may be coated or otherwise disposed on the substrate. Such additional layers may be interchangeably referred to herein as “coating,” “overmolding,” “overinjection,” “outer” or “secondary” layers. In some embodiments, such layers include PET layers, RPET layers, other recycled materials, barrier layers, UV protection layers, oxygen scavenging layers, oxygen barrier layers, carbon dioxide scavenging layers, carbon dioxide barrier layers, water-resistant coating layers, foam layers and/or other layers as needed or desired for the particular application or use. In addition, a number of additives make be included in any of coating or substrate layers. Suitable materials for these types of materials are further described herein.

Examples of materials that may be used in a gas barrier layer include one or more vinyl alcohol polymers and copolymers (PVOH, EVOH, EVA), thermoplastic epoxy resins such as phenoxy-type thermoplastics (including hydroxy-functional poly(amide ethers), poly(hydroxy amide ethers), amide- and hydroxymethyl functionalized polyethers, hydroxy-functional polyethers, hydroxy-functional poly(ether sulfonamides), poly(hydroxy ester ethers), hydroxy-phenoxyether polymers, and poly(hydroxyamino ethers)), polyester and copolyester materials (PETG, PEN), linear low density polyethylene (LLDPE), poly(cyclohexylenedimethylene terephthalate), polylactic acid (PLA), polycarbonates, polyglycolic acid (PGA), polyethylene imines, urethanes, acrylates, polystyrene, cycloolefins, poly-4-methylpentene-1, poly(methyl methacrylate), acrylonitrile, polyvinyl chloride, polyvinylidine chloride (PVDC), styrene acrylonitrile, acrylonitrile-butadiene-styrene, polyacetal, polybutylene terephthalate, polysulfone, polytetra-fluoroethylene, polytetramethylene 1,2-dioxybenzoate, and copolymers of ethylene terephthalate and ethylene isophthalate, and copolymers and/or blends of one any of the foregoing. In certain embodiments, it is preferable that the gas barrier layer have a permeability to oxygen and carbon dioxide less than the substrate layer.

Examples of materials that may be used in a water resistant layer include polyesters, acrylics, (meth)acrylic(alkyl) polymers and copolymers (EAA), polyolefins polymers or copolymers (PP, PE), a (meth)acrylic acid polymer or copolymer, a wax (carnauba, paraffin, polyethylene, polypropylene and Fischer-Tropsch), paraffins and/or the like.

In some embodiments, a foamed or an elastic material may be used in a layer of the preforms or other articles. In some embodiments, the foam material can comprise thermoplastic, thermoset, or polymeric material, such as ethylene acrylic acid (“EAA”), ethylene vinyl acetate (“EVA”), linear low density polyethylene (“LLDPE”), polyethylene terephthalate glycol (PETG), poly(hydroxyamino ethers) (“PHAE”), PET, polyethylene, polypropylene, polystyrene (“PS”), pulp (e.g., wood or paper pulp of fibers, or pulp mixed with one or more polymers), mixtures thereof, and the like. In certain embodiments, these materials are mixed with a blowing agent such as microspheres, or other known blowing agents depending on the exact foam material used. In certain embodiments, an elastomeric or plastomeric material may be used including polyolefin elastomers (such as ethylene-propylene rubbers), polyolefin plastomers, modified polyolefin elastomers (such as ter-polymers of ethylene, propylene and styrene), modified polyolefin plastomers, thermoplastic urethane elastomers, acrylic-olefin copolymer elastomers, polyester elastomers, and combinations thereof.

In some embodiments, certain adhesion materials may be added to one or more layers, or may be used in a tie layer between adjacent layers. Suitable adhesive materials include polyolefins, modified polyolefin composition (e.g., grafted or modified with polar groups, such as PPMA, PEMA), polyethyleneimine (PEI). Adhesion enhancers may also be used in any layer. Suitable adhesion enhancers include zirconium and titanium salts and organic aldehydes

One or more layers may also include additives, such as nanoparticle barrier materials, oxygen scavengers, UV absorbers, colorants, dyes, pigments, abrasion resistant additives, fillers, anti-foam/bubble agents, and the like. Additives known by those of ordinary skill in the art for their ability to provide enhanced CO₂ barriers, O₂ barriers, UV protection, scuff resistance, blush resistance, impact resistance, water resistance, and/or chemical resistance are among those that may be used. One nonlimiting example of a gas barrier additive is a derivative of resorcinol (m-dihydroxybenzene), such as resorcinol diglycidyl ether and hydroxyethyl ether resorcinol.

Suitable cross linkers can be chosen depending upon the chemistry and functionality of the resin or material to which they are added. For example, amine cross linkers may be useful for crosslinking resins comprising epoxide groups. Curing enhancers may also be used, such as radiation absorbing additives (e.g., carbon black), and transition metals.

Additional disclosure regarding these materials is provided in U.S. patent application Ser. No. 10/614,731 (U.S. Publication No. 2004-0071885); Ser. No. 11/108,607 (U.S. Publication No. 2006-0073298); Ser. No. 11/512,002 (U.S. Publication No. 2007-0108668); Ser. No. 11/405,761 (U.S. Publication No. 2006-0292323); Ser. No. 11/546,654 (U.S. Publication No. 2007-0087131); U.S. provisional application 60/912,675, filed Apr. 18, 2007, all of which are hereby incorporated by reference herein in their entireties.

### B. Detailed Description of the Drawings

In certain embodiments, one or more injection molding systems or devices are described. In addition, preforms and other formed articles produced by such systems and apparatuses are also disclosed. Articles described herein may be mono-layer or multi-layer (i.e., two or more layers). In some embodiments, the articles can be packaging, such as drinkware (including preforms, containers, bottles, closures, etc.), boxes, cartons, tray, sheets, and the like.

Multi-layer articles disclosed herein may comprise an inner layer (e.g., the layer that is in contact with the contents of the container) of a material approved by a regulatory agency (e.g., the U.S. Food and Drug Association) or material having regulatory approval to be in contact with food (including beverages), drugs, cosmetics, etc. In other embodiments, an inner layer comprises material(s) that are not approved by a regulatory scheme to be in contact with food. A second layer may comprise a second material, which can be similar to or different than the material forming the inner layer. As discussed, such a coating or overmolding layer can comprises virgin PET, RPET and/or any other polyester and/or other type of thermoplastic. The articles can have as many layers as desired or required. It is contemplated that the preforms or other articles can comprise one or more materials that form various portions that are not “layers.”

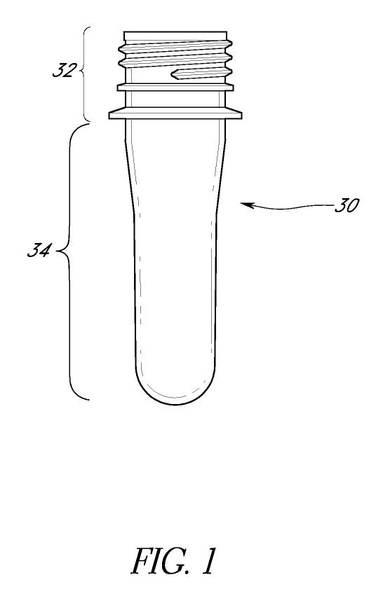

Referring to FIG. 1, a preferred monolayer preform 30 is illustrated. The preform is preferably made of an FDA approved material, such as virgin PET, and can be of any of a wide variety of shapes and sizes. The preform shown in FIG. 1 is of the type which will form a carbonated beverage bottle (e.g., 16 oz bottle) or other container. In some embodiments, as discussed herein, the preform or other molded item can comprise one or more overmolding or coating layers of PET, RPET and/or other recycled materials. In other arrangements, preforms can have an oxygen and/or a carbon dioxide barrier either in addition or in lieu of layers of RPET. However, as understood by those skilled in the art, other preform configurations can be used depending upon the desired configuration, characteristics and use of the final article. The monolayer preform 30 may be made by methods disclosed herein.

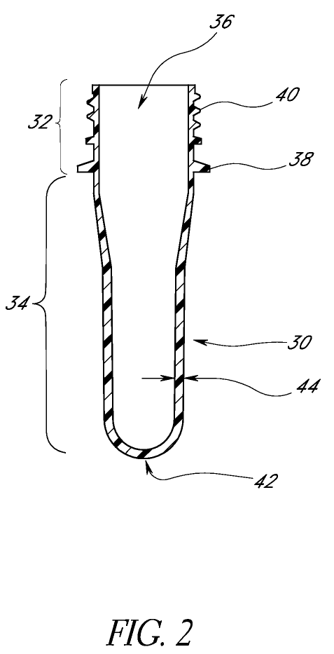

Referring to FIG. 2, a cross-section of the preform 30 of FIG. 1 is illustrated. The preform 30 has a neck portion 32 and a body portion 34, formed monolithically (i.e., as a single or unitary structure). Advantageously, the monolithic arrangement of the preform, when blow-molded into a bottle, provides greater dimensional stability and improved physical properties in comparison to a preform constructed of separate neck and body portions, which are bonded together. However, preforms can comprise a neck portion and body portion that are bonded together.

In some embodiments, the neck portion 32 begins at the opening 36 to the interior of the preform 30 and extends to and includes a support ring 38 or other structure. The neck portion 32 is further characterized by the presence of the threads 40, which provide a way to fasten a cap for the bottle produced from the preform 30. Alternatively, the neck portion 32 can be configured to engage a closure or cap (e.g., a crown closure, cork (natural or artificial), snap cap, punctured seal, and/or the like). The body portion 34 is an elongated and cylindrically shaped structure extending down from the neck portion 32 and culminating in a rounded end cap 42. The preform thickness 44 will depend upon the overall length of the preform 30 and the wall thickness and overall size of the resulting container.

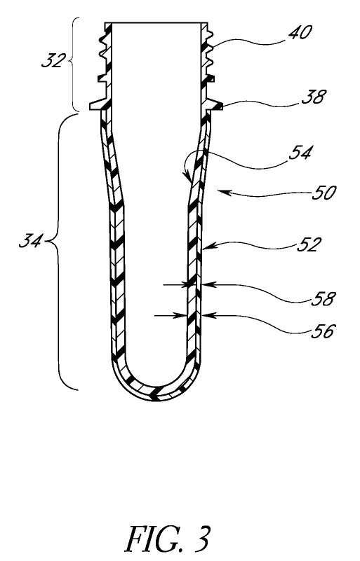

Referring to FIG. 3, a cross-section of one embodiment of a multilayer preform 50 is disclosed. The illustrated preform 50 includes a neck portion 32 and a body portion 34 similar to the preform 30 of FIGS. 1 and 2. The layer 52 can be disposed about the entire surface of the body portion 34, terminating at the bottom of the support ring 38. The coating layer 52 in the depicted embodiment does not extend to the neck portion 32, nor is it present on the interior surface 54 of the preform which is preferably made of one or more FDA-approved materials, such as PET. The coating layer 52 may comprise either a single material or several microlayers of at least two materials. By way of example, the wall of the bottom portion of the preform may have a thickness of 3.2 millimeters; the wall of the neck, a cross-sectional dimension of about 3 millimeters; and the material applied to a thickness of about 0.3 millimeters. The coating or overmolding layer 52 may comprise PET, RPET, a barrier material, foam and/or other polymer materials suitable for forming an outer surface of a preform.

The overall thickness 56 of the preform is equal to the thickness of the initial uncoated preform 39 plus the thickness 58 of the outer or coating layer 52, and is dependent upon the overall size and desired coating thickness of the resulting container (e.g., carbonated beverage bottle). However, the preform 50 may have any thickness depending on the desired or required thermal, structural and/or other types of properties of the container formed from the preform 50. The preforms and containers can have layers which have a wide variety of relative thicknesses.

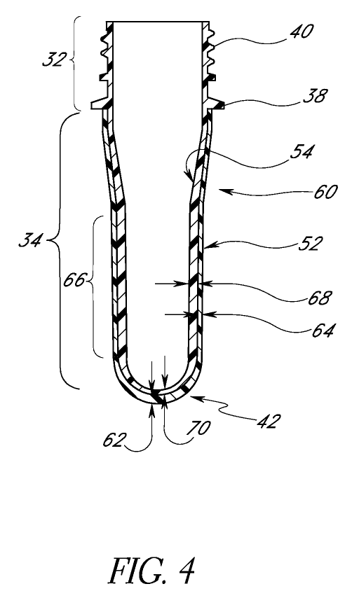

Referring to FIG. 4, one embodiment of a multilayer preform 60 is shown in cross-section. The primary difference between the coated preform 60 and the coated preform 50 in FIG. 3 is the relative thickness of the two layers in the area of the end cap 42. The preform 50 of FIG. 3 has an outer layer 52 that is generally thinner than the thickness of the inner layer of the preform throughout the entire body portion of the preform. The preform 60, however, has an outer layer 52 that is thicker at 62 near the end cap 42 than it is at 64 in the wall portion 66, and conversely, the thickness of the inner layer is greater at 68 in the wall portion 66 than it is at 70, in the region of the end cap 42. This preform design can be useful when the outer layer which is applied to the initial preform in an overmolding process to make the coated preform, as described herein. Such an arrangement can provide certain advantages including, but not limited to, reduction in total molding cycle time. The layer 52 may be homogeneous or it may comprise a plurality of microlayers. In other embodiments, however, the relative thicknesses of the various layers of the preform can be different than discussed and/or illustrated herein.

Multilayer preforms and containers can have layers which have a wide variety of relative thicknesses. In view of the present disclosure, the thickness of a given layer and of the overall preform or container, whether at a given point or over the entire container, can be chosen to fit a particular molding process or a particular end use for the container. Furthermore, as discussed herein in regard to FIG. 3, an outer or overmolding layer of a preform or container can comprise a single material or several microlayers of two or more materials.

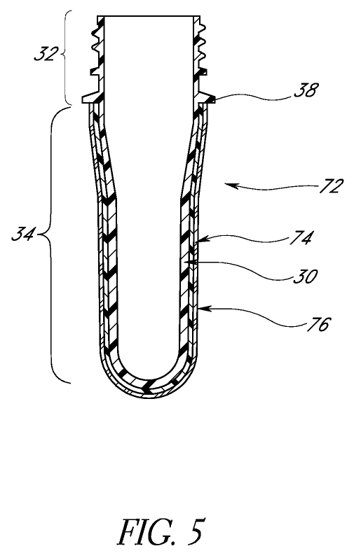

FIG. 5 illustrates one embodiment of a three-layer preform 72. The depicted arrangement of a multi-layer preform can be produced by placing two coating or overmolding layers 74 and 76 on a monolayer preform, such as preform 30 shown in FIG. 1.

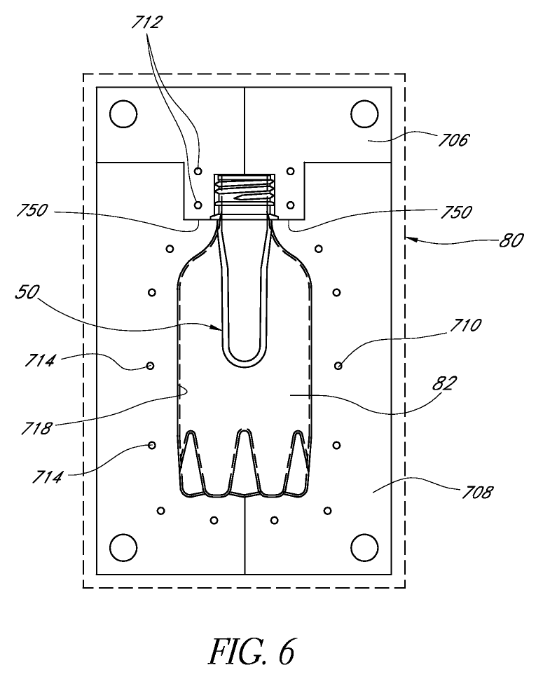

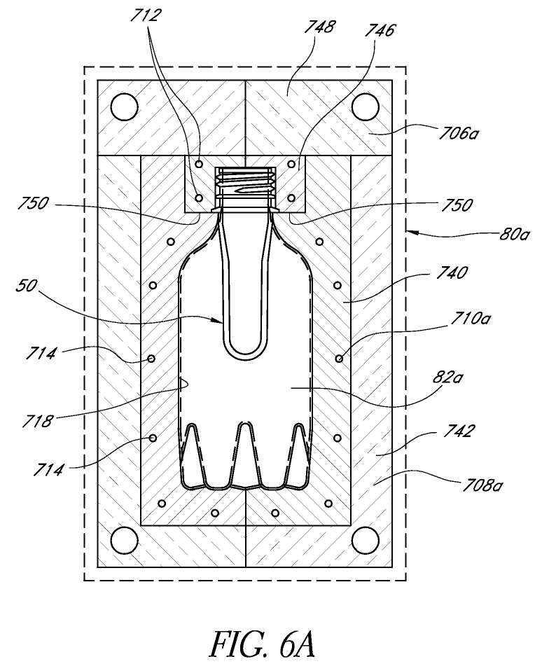

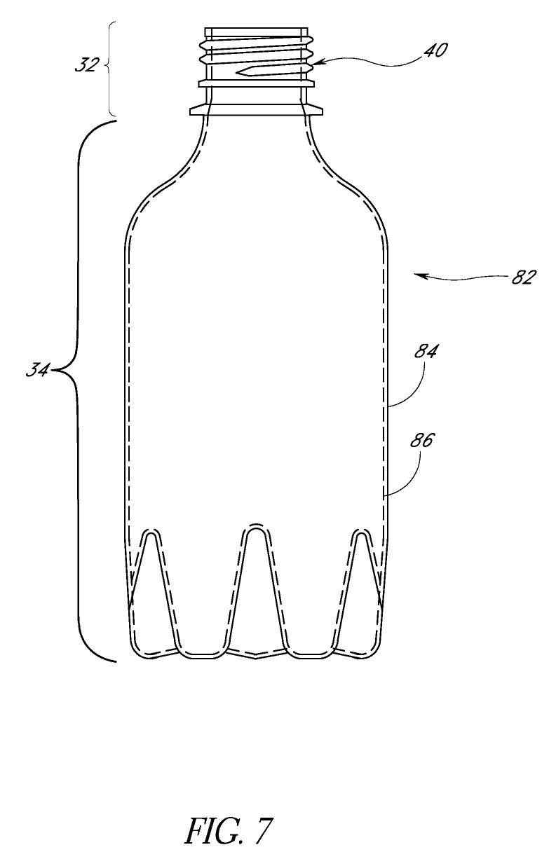

After a preform, such as that illustrated in FIG. 3, is prepared by a method and apparatus such as those discussed in detail below, it can be subjected to a stretch blow-molding process. Accordingly, with reference to FIG. 6, a multilayer preform 50 can be placed in a mold 80 having a cavity corresponding to the desired container shape. The preform is then heated and expanded by stretching and/or by forcing air into the interior of the preform 50 to fill the cavity within the mold 80, creating a container 82 (FIG. 7). The blow molding operation normally is restricted to the body portion 34 of the preform with the neck portion 32 including the threads, pilfer ring, and support ring retaining the original configuration as in the preform. Monolayer and multilayer containers can be formed by stretch blow molding monolayer and multilayer preforms, respectively.

FIG. 6A illustrates a stretch blow mold configured to improve cycle times and thermal efficiency. The temperature of the walls of the mold 80A can be precisely controlled to achieve the desired temperature distribution through the blow molded container.

Referring to FIG. 7, there is disclosed an embodiment of container 82 in accordance with a preferred embodiment, such as that which might be made from blow molding the multilayer preform 50 of FIG. 3. The container 82 has a neck portion 32 and a body portion 34 corresponding to the neck and body portions of the preform 50 of FIG. 3. The neck portion 32 is further characterized by the presence of the threads 40 which provide a way to fasten a cap onto the container.

In some embodiments, the outer or overmolding layer 84 covers the exterior of the entire body portion 34 of the container 82, stopping just below the support ring 38. The interior surface 86 of the container, which can comprise an FDA-approved material, preferably PET, can remain uncoated so that only the interior surface 86 is in contact with beverages or foodstuffs. In some embodiments that may be used as a carbonated beverage container, the thickness 87 of the layer is preferably about 0.508 mm-1.524 mm (0.020-0.060 inch), more preferably about 0.762 mm-1.016 mm (0.030-0.040 inch); the thickness 88 of the PET layer is preferably about 2.032 mm-4.064 mm (0.080-0.160 inch), more preferably about 2.54 mm-3.556 mm (0.100-0.140 inch); and the overall wall thickness 90 of the multilayer container 82 is preferably about 3.556 mm-4.562 mm (0.140-0.180 inch), more preferably about 3.82 mm-4.318 mm (0.150-0.170 inch). In some embodiments, the wall of the container 82 can derive the majority of its thickness from an inner PET layer. In some arrangements, the container 82 can be a monolayer container. For example, the container 82 can be made by stretch blow molding the preform 30 of FIG. 1. Additional articles and associated materials are disclosed in U.S. patent application Ser. No. 11/108,345 entitled MONO AND MULTI-LAYER ARTICLES AND INJECTION METHODS OF MAKING THE SAME, filed on Apr. 18, 2005 and published as U.S. Publication No. 2006/0073294, that can be made by the systems disclosed herein.

### C. Injection Molding Methods, Apparatuses and Systems

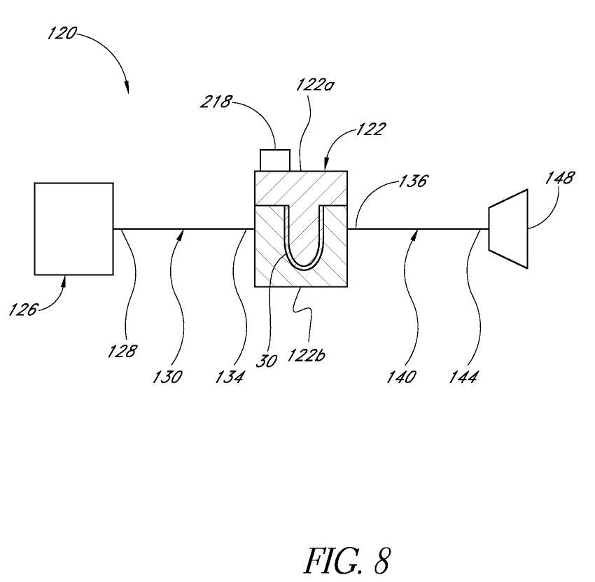

FIG. 8 schematically illustrates a temperature control system 120 in accordance with one embodiment. The illustrated arrangement of a temperature control system 120 is an open loop system. The temperature control system 120 can be used to control the temperature of a mold apparatus 122. The mold apparatus 122 can be configured to mold a single article or a plurality of articles. The mold apparatus 122 can be configured to form articles of any shape and configuration. For example, the mold apparatus 122 can be designed to produce preforms, containers, and other articles that are formed by molds. In some embodiments, the mold apparatus 122 can be a stretch blow-molding apparatus, injection molding apparatus, compression molding apparatus, thermomolding or thermoforming system, vacuum forming system, and the like. The mold apparatus 122 may or may not comprise high heat transfer material. Some exemplary temperature control systems employ a working fluid or other means for controlling the temperature of the mold apparatus during the molding process. The illustrated temperature control system 120 has a working fluid passing through the mold apparatus 122 to control the temperature of the polymer in the mold apparatus 122. The working fluid can be at a wide range of temperatures depending on the particular application.

The illustrated mold apparatus 122 comprises a plurality of mold sections that cooperate to define a molding cavity. In some embodiments, the mold apparatus 122 comprises a mold section 122a and mold section 122b movable between an open position and a closed position. The mold section 122a and the mold section 122b can form a mold cavity sized and configured to make preforms, such as the preform 30 as illustrated. The mold apparatus 122 can also be designed to form a layer of a multilayer preforms or other articles. The temperature control system 120 can be used selectively control the temperature of the mold apparatus 122 to reduce cycle time, produce a desired finish (e.g., an amount of crystallinity), improve mold life, improve preform quality, etc.

With continued reference to the embodiment illustrated in FIG. 8, the temperature control system 120 includes fluid lines 130, 140. The fluid line 130 connects a fluid source 126 to the mold apparatus 122, and the fluid line 140 connects the mold apparatus 122 to an exhaust system 148. Fluid lines can define flow paths of the working fluid passing through the system 120.

As used herein, the term “fluid source” is a broad term and is used in its ordinary sense and refers, without limitation, to a device which is suitable for providing fluid that can be used to maintain the mold apparatus 122 at a suitable temperature. In various embodiments, the fluid source may comprise a bottle, canister, compressor system, or any other suitable fluid delivery device. The fluid source 126 might contain a quantity of liquid, preferably a refrigerant. For example, the fluid source 126 can comprise one or more refrigerants, such as Freon, Refrigerant 12, Refrigerant 22, Refrigerant 134a, and the like. The fluid source 126 can also comprise cryogenic fluids, such as liquid carbon dioxide (CO₂) or nitrogen (N₂). In some embodiments, the working fluid can be conveniently stored at room temperature. For example, CO₂ or nitrogen is liquid at typical room temperatures when under sufficient pressure. In some non-limiting embodiments, the pressure of the stored fluid in the fluid source 126 will often be in the range of about 40 bars to about 80 bars. In some embodiments, the fluid source 126 is a bottle and the pressure in the bottle will be reduced during the molding of preforms as fluid from the bottle is consumed. The fluid source 126 can contain a sufficient amount of fluid so that the mold apparatus 122 can be cooled for many cycles, as described below. The fluid source 126 may have a regulator to control the flow of fluid into the fluid line 130 and may comprise a compressor that can provide pressure to the fluid in the fluid line 130. Optionally, the working fluid of the temperature control system can comprise a combination of two or more of the aforementioned fluids to achieve the desired thermal characteristics of the working fluid. In some embodiments, the percentages of the components of the working fluids can be selected based on the desired temperatures and pressures so that the components of the working fluid do not solidify, for example. Other working fluids, such as water, can also be employed to control the temperature of molding apparatus. Of course, refrigerants can be used to more rapidly heat and/or cool the mold apparatus and associated molded articles as compared to non-refrigerants, such as water.

As used herein, the term “refrigerant” is a broad term and is used in its ordinary sense and refers, without limitation, to non-cryogenic refrigerants (e.g., Freon) and cryogenic refrigerants. As used herein, the term “cryogenic refrigerant” is a broad term and is used in its ordinary sense and refers, without limitation, to cryogenic fluids. As used herein, the term “cryogenic fluid” means a fluid with a maximum boiling point of about −50° C. at about 5 bar pressure when the fluid is in a liquid state. In some non-limiting embodiments, cryogenic fluids can comprise CO₂, N₂, Helium, combinations thereof, and the like. In some embodiments, the cryogenic refrigerant is a high temperature range cryogenic fluid having a boiling point higher than about −100° C. at about 1.013 bars. In some embodiments, the cryogenic refrigerant is a mid temperature range cryogenic fluid having a boiling point between about −100° C. and −200° C. In some embodiments, the cryogenic refrigerant is a low temperature range cryogenic fluid having a boiling point less than about −200° C. at about 1.013 bars.

The heat load capabilities of a temperature control system using a non-cryogenic fluid may be much less than the heat load capabilities of a temperature control system using cryogenic fluid. Further, non-cryogenic refrigerants may lose its effective cooling ability before it reaches critical portions of the mold. For example, Freon refrigerant may be heated and completely vaporized after it passes through the expansion valve but before it reaches critical mold locations and, thus, may not effectively cool the mold surfaces. The temperature control systems using cryogenic fluid can provide rapid cooling and/or heating of the molding surface of the mold apparatus to reduce cycle times and increase mold output.

In one embodiment, a fluid source inlet 128 of the fluid line 130 is connected to the fluid source 126, and the fluid line 130 has an outlet 134 leading to mold apparatus 122. Fluid from the fluid source 126 can pass through the fluid source inlet 128 into the fluid line 130 and out of the outlet 134 to the mold apparatus 122. The fluid line 130 is a conduit, such as a pipe or hose, in which pressurized fluid can pass. For example, in the illustrated embodiment of FIG. 8, fluid in the fluid line 130 is a liquid refrigerant at a pressure of about 40 bars to about 80 bars.

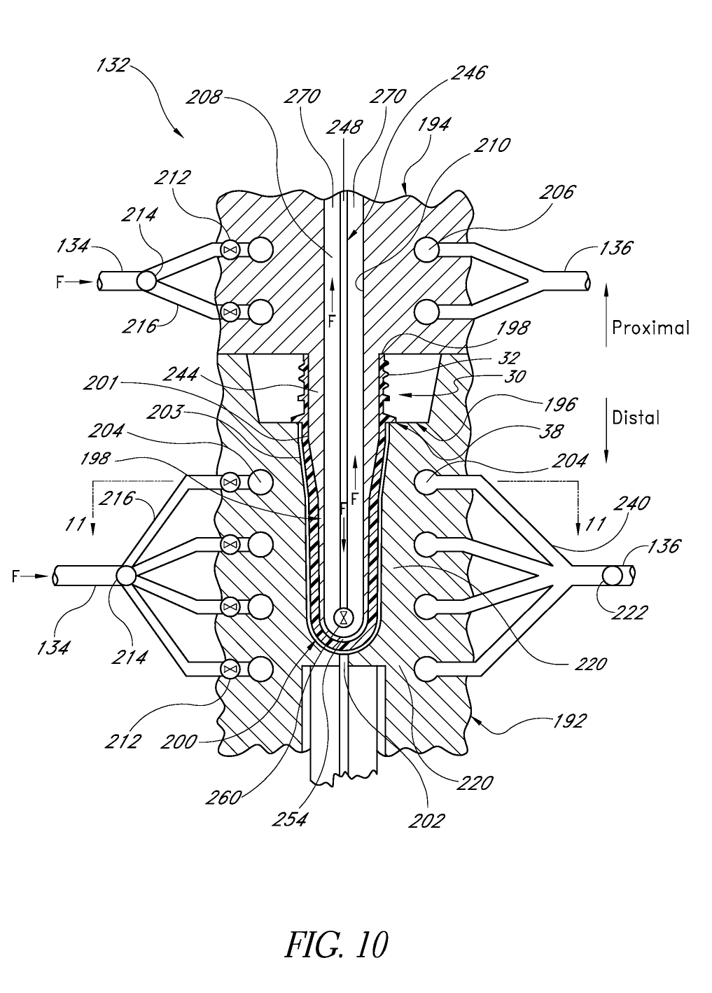

Fluid from the fluid line 130 passes through the mold apparatus 122 to control the temperature of the mold apparatus 122. In some embodiments, the fluid passes through one or more flow control devices (e.g., pressure reducing elements, valves, and the like) located upstream of or within the mold apparatus 122. The flow control devices receive the fluid (preferably a liquid) at a high pressure and output a low pressure and temperature fluid (e.g., gas or gas/liquid mixture) to one or more flow passageways in the mold apparatus 122. As shown in FIG. 10, for example, the fluid can pass through a plurality of pressure reducing elements 212 in into a plurality of fluid passageways or channels 204 to selectively control the temperature of the preform. The fluid circulating through the mold apparatus of FIG. 10 cools the warm melt to form a multilayer preform.

As used herein, the term “pressure reducing element” is a broad term and is used in its ordinary sense and refers, without limitation, to a device configured to reduce the pressure of a working fluid. In some embodiments, the pressure reducing element can reduce the pressure of the working fluid to a pressure equal to or less than a vaporization pressure of the working fluid. The working fluid can comprise a refrigerant (e.g., a cryogenic refrigerant or a non-cryogenic refrigerant). In some embodiments, the pressure reducing elements are in the form of pressure reduction or expansion valves that cause vaporization at least a portion of the working fluid passing therethrough. The pressure reducing element can have a fixed orifice or variable orifice. In some embodiments, the pressure reducing element can be a nozzle valve, needle valve, Joule-Thomson expansion valve, or any other suitable valve for providing a desired pressure drop. For example, a Joule-Thomson expansion valve can recover work energy from the expansion of the fluid resulting in a lower downstream temperature. In some embodiments, the pressure reducing element vaporizes an effective amount of the working fluid (e.g., a cryogenic fluid) to reduce the temperature of the working fluid such that the working fluid can sufficiently cool an article within a mold to form a dimensionally stable outer surface of the article. In some embodiments, the pressure reducing elements can be substituted with flow regulating elements (e.g., a valve system) especially if the working fluid is a non-refrigerant, such as water.

With reference again to FIG. 8, after the working fluid passes through the mold apparatus 122, the fluid passes through the inlet 136 and through the fluid line 140 and out of an outlet 144 to the exhaust system 148. The fluid line 140 is a conduit, such as pipe or hose, in which pressurized fluid can pass. In some embodiments, the fluid in the fluid line 140 is at a pressure less than about 10 bars, 5 bars, 3 bars, 2 bars, and ranges encompassing such pressures. Of course, the pressure of working fluid may be different depending on the application.

The exhaust system 148 can receive and discharge the fluid from the fluid line 140. The exhaust system 148 can include one or more valves that can control the pressure of the fluid in the fluid line 140 and the amount of fluid emitted from the temperature control system 120. The exhaust system 148 can include one or more fans and/or vents to further ensure that the fluid properly passes through the temperature control system 120. Preferably, the fluid is in the form of a gas that is discharged into the atmosphere by the exhaust system 148. Thus, fluid from the fluid source 126 passes through the fluid line 130, the mold apparatus 122, the fluid line 140, and out of the exhaust system 148 into the atmosphere. Preferably, the working fluid of the temperature control system 120 is a refrigerant, including cryogenic refrigerants like nitrogen, hydrogen, or combinations thereof. These fluids can be conveniently expelled into the atmosphere unlike some other refrigerants which may adversely affect the environment.

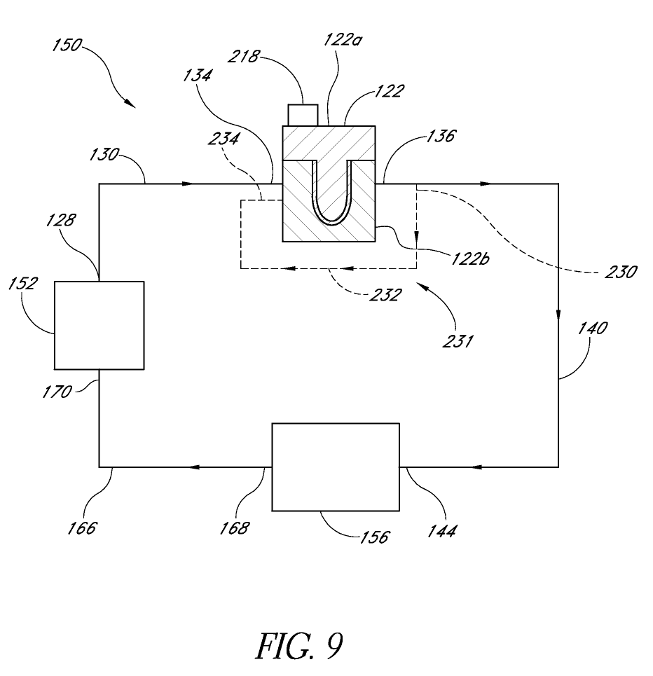

FIG. 9 illustrates an additional embodiment of a temperature control system for controlling the temperature of mold apparatuses. Such temperature control systems may be generally similar to the embodiment illustrated in FIG. 8, except as further detailed below. Where possible, similar or identical elements of FIGS. 8 and 9 are identified with identical reference numerals.

FIG. 9 schematically illustrates a temperature control system 150, which is a closed loop system designed to control the temperature of the mold apparatus 122 during preform manufacturing. The temperature control system 150 has a fluid source 152 in communication with the mold apparatus 122. The mold apparatus 122 is in communication with a unit 156, which is in communication with the fluid source 152. To cool the mold apparatus 122, the working fluid can flow clockwise as indicated by the arrow heads.

The fluid source 152 is connected to an outlet 170 of a fluid line 166 and is connected to the source inlet 128 of the fluid line 130. The fluid source 152 receives fluid from the fluid line 166 and delivers fluid to the fluid line 130. The fluid source 152 can store the working fluid before, during, and/or after a production cycle.

As illustrated in FIG. 9, the fluid line 130 is connected to the fluid source 152 and the mold apparatus 122 in the manner described above. The fluid line 140 is in fluid communication with the mold apparatus 122 and the unit 156. The mold inlet 136 of the line 140 is connected to the mold apparatus 122, and the outlet 144 of the line 140 is connected to the unit 156. Fluid passes from the mold apparatus 122 into the inlet 136 and through the fluid line 140 to the outlet 144. The fluid then passes through the outlet 144 and into the unit 156.

The unit 156 can recondition the fluid so that the fluid can be redelivered to the mold apparatus 122 for continuous flow through the temperature control system 150. The unit 156 can include a compressor and/or heat exchanger. The fluid can flow through a compressor which pressurizes the fluid and then flows through a heat exchanger (e.g., a condenser) that reduces the temperature of the pressurized fluid. In some instances, the terms “heat exchanger” and “condenser” can be used interchangeably herein. Preferably, the unit 156 outputs a low temperature liquid to an inlet 168 of the fluid line 166. Fluid from the unit 156 can therefore pass through the fluid line 166 into the fluid source 152 by way of the outlet 170.

The unit 156 can change modes of operation to heat the mold apparatus 122, and the molded articles disposed therein. The working fluid can flow counter-clockwise through the temperature control system 150 to heat the mold apparatus 122. In one embodiment, the unit 156 receives cool fluid (preferably a liquid) from the fluid line 166 and delivers a high temperature gas or gas/liquid mixture, as compared to the cool liquid, to the fluid line 140. The high temperature fluid can heat the mold apparatus 122 and article disposed therein. The unit 156 can thus include an evaporator and/or compressor for heating the working fluid. Thus, the unit 156 can be used to change the mode of operation to heat or cool the mold apparatus 122 as desired.

With continued reference to FIG. 9, the temperature control system 150 can cool at least a portion of the mold apparatus 122, which in turn cools the plastic in the mold apparatus 122. In one embodiment, the fluid source 152 delivers refrigerant, such as cryogenic fluid (preferably liquid carbon dioxide or nitrogen), to the fluid line 130 and the mold apparatus 122.

The liquid passes through a portion of the mold apparatus 122 and is delivered to one or more pressure reducing elements 212 (see FIG. 10). The pressure reducing elements 212 preferably receive the liquid at a high pressure and output fluid (e.g., gas or gas/liquid mixture) at a low temperature to the channels in the mold apparatus 122. The pressure reducing element 212 can reduce the temperature of the working fluid passing therethrough. The fluid passes through and cools portions of the mold apparatus 122, thereby cooling the polymer in the mold apparatus.

As shown in FIG. 9, the mold apparatus 122 delivers the heated fluid to the fluid line 140, which, in turn, delivers the fluid to the unit 156 functioning as a compressor and condenser. The unit 156 outputs fluid in the form of a low temperature liquid to the fluid line 166 and the source 152.

In some embodiments, including the illustrated embodiment of FIG. 9, the temperature control system 150 can have an optional a feedback system 231 for delivering heated fluid from the mold apparatus 122 back into and through the mold apparatus 122. In operation, fluid in the fluid line 140 passes through the feedback system 231 to mold apparatus 122 via a feedback line 232. Preferably, the temperature of the fluid in the feedback line 232 is at a temperature higher than the temperature of the fluid in the fluid line 130. Different portions of the mold apparatus 122 can be maintained at different temperatures by utilizing both the fluid from the fluid line 130 and the feedback line 232. The fluid in the feedback line may or may not be at a temperature of the melt deposited into the mold apparatus. One or more valve systems can be disposed along the lines 130, 232 to regulate the flow of fluid through the mold apparatus 122. In some embodiments, the heating of the mold apparatus 122 by the utilizing the fluid from the feedback line 232 can be performed when the fluid flow from the source 152 to the mold apparatus 122 is reduced or stopped. In some embodiments, the heated fluid from the feedback line 232 can be used to reduce the rate of cooling of the melt in the mold apparatus 122 to, for example, produce a high degree of crystallinity in the molded article. A variety of temperature distributions can be achieved in the mold by utilizing working fluids at different temperatures.

As discussed above, the temperature control system 150 can also heat at least a portion of the mold apparatus 122 by circulating the working fluid in the counterclockwise direction. In one embodiment, the fluid source 152 delivers fluid to the fluid line 166, which delivers the fluid to the unit 156. The unit 156 can function as a compressor and can increase the temperature of the working fluid. In some embodiments, the unit 156 can receive a fluid (e.g., a two-phase working fluid) from the line 162. The temperature of the two-phase working fluid can be increased by the unit 156 and then delivered to the line 140.

The unit 156 delivers heated fluid (e.g., a high temperature gas or gas/liquid mixture) to the fluid line 140. The fluid is then delivered to and passes through the mold apparatus 122. The fluid passing through the passageways in the mold apparatus 122 heats one or more portions of the mold, which in turn heats or reduces the rate of cooling of the polymer in the mold apparatus 122. The fluid is cooled as it passes through the mold apparatus 122 and is delivered to the fluid line 130, which delivers the cooled fluid to the fluid source 152. The fluid source 152 then delivers the fluid to the fluid line 166 as described above. Thus, fluid flows in one direction through the temperature control system 150 to cool the mold apparatus 122 and flows in the opposite direction through the temperature control system 150 to heat the mold apparatus 122. Further, the flow of fluid can be reversed one or more times during preform production to heat (e.g., reduce the rate of cooling of the melt) and cool the mold repeatedly as desired.

The fluid source of the temperature control systems can comprise a plurality of fluid sources. Each of the fluid sources can contain a different working fluid. For example, although not illustrated, the temperature control system 150 of FIG. 9 can have a second fluid source containing a second fluid. The second fluid can have a freezing point that is higher than the temperature of the vaporized fluid from the first fluid source 152, as discussed above. It is contemplated that additional fluid sources can be added to any of the fluid systems described herein. Accordingly, any number of fluid sources and working fluids can be used to control the temperature of the mold apparatus. It will be appreciated that pressure-reducing valves or other elements can be included on cooling channels or other conduits for any of the embodiments of a mold device or system disclosed herein. Additional embodiments of temperature control systems are disclosed in U.S. Pat. No. 7,303,387 titled METHODS AND SYSTEMS FOR CONTROLLING MOLD TEMPERATURES, the entirety of which is hereby incorporated by reference herein.

The features, components, systems, subsystems, devices, materials, and methods of the temperature control systems disclosed herein or incorporated by reference herein can be mixed and matched by one of ordinary skill in this art in accordance with principles described herein. Additionally, one or more check valves, pressure sensors, flow regulators, fluid lines, temperature sensors, detectors, and the like can be added to the temperature control systems as desired.

Monolayer and multilayer articles (including packaging such as closures, preforms, containers, bottles) can be formed by an injection molding process. One method of producing multi-layered articles is referred to herein generally as overmolding. Multilayer preforms can be formed by overmolding by, e.g., an inject-over-inject (“IOI”) process. The name refers to a procedure which uses injection molding to inject one or more layers of a material over an existing preform or substrate, which preferably was itself made by injection molding. The terms “overinjecting” and “overmolding” are used herein to describe the molding process whereby a layer of material is injected over an existing preform. In an especially preferred embodiment, the overinjecting process is performed while the underlying preform has not yet fully cooled. Overinjecting may be used to place one or more additional layers of materials, such as those comprising PET, RPET, other recycled materials, barrier material, recycled PET, foam material, or other materials over a monolayer or multilayer preform.

Molding may be used to place one or more layers of material(s) such as those comprising lamellar material, PP, foam material, PET (including recycled PET, virgin PET), barrier materials, phenoxy type thermoplastics, combinations thereof, and/or other materials described herein over a substrate (e.g., the underlying layer). In some non-limiting exemplary embodiments, the substrate is in the form of a preform, preferably having an interior surface suitable for contacting foodstuff. The temperature control systems can be utilized to control the temperature of preforms formed by these molding processes. The temperature control systems can also be used when forming a single monolayer preform, as described below in detail.

Articles made by a molding process may comprise one or more layers or portions having one or more of the following advantageous characteristics: one or more outer layers of RPET, PET or other recycled materials, an insulating layer, a barrier layer, a foodstuff contacting layer, a non-flavor scalping layer, a high strength layer, a compliant layer, a tie layer, a gas scavenging layer, a layer or portion suitable for hot fill applications, a layer having a melt strength suitable for extrusion. In one embodiment, the monolayer or multi-layer material comprises one or more of the following materials: PET (including recycled (e.g., RPET) and/or virgin PET), PETG, foam, polypropylene, phenoxy type thermoplastics, polyolefins, phenoxy-polyolefin thermoplastic blends, and/or combinations thereof. For the sake of convenience, articles are described primarily with respect to preforms and containers.

FIG. 10 illustrates one embodiment of a mold apparatus 132 for use in methods which utilize overmolding. The mold apparatus 132 can form a layer on the preform 30 to form a multilayer preform, such as the preform 50 of FIG. 3. The temperature control systems described herein can be used to control the temperature of the mold apparatus 132, and the other molds described herein.

As shown, the mold apparatus 132 can include two halves, a cavity section 192 and a core section 194. The cavity section 192 comprises a cavity in which the preform is placed. The core section 194 and the cavity section 192 are movable between a closed position and an open position. The preform can be a monolayer preform (illustrated) or a multilayer preform. The preform 30 is held in place between the core section 194, which exerts pressure on the top of the preform and the ledge 196 of the cavity section 192 on which the support ring 38 rests. The neck portion 32 of the preform 30 is thus sealed off from the body portion of the preform 30. Inside the preform 30 is the core 198. As the preform 30 sits in the mold apparatus 132, the body portion of the preform 30 is completely surrounded by a void space 200. The space 200 is formed by outer surface of the preform 30 and a cavity molding surface 203 of the cavity section 192. The preform, thus positioned, acts as an interior die core in the subsequent injection procedure, in which the melt of the overmolding material is injected through the gate 202 into the void space 200 to form an outer layer of the preform.

As discussed, the cavity section 192 and/or the core section 194 have one or more temperature control elements 204. The temperature control elements 204 are in the form of a plurality of passageways or channels for controlling the temperature of the melt and the preform 30. Fluids flowing through the channels 204 can, for example, cool the mold apparatus 132, which in turn cools the injected melt. In the illustrated embodiment of FIG. 10, the cavity section 192 has a plurality of channels 204 while the core section 194 also has a plurality of channels 206. A plurality of pressure reducing elements 212 are positioned upstream of the channels 204, 206. The pressure reducing elements 212 are positioned within the cavity section 192 and the core section 194. However, the pressure reducing elements 212 can be positioned outside of the cavity section 192 and/or the core section 194. In the illustrated embodiment, there is an upper outlet 134 and a lower outlet 134 that deliver fluid to the channels 206, 204, respectively.

With continued reference to FIG. 10, the mold outlets 134 can have a flow regulator 214 in fluid communication with the pressure reducing elements 212. The flow regulator 214 can be a valve system that selectively controls the flow of fluid to the channels 204. A plurality of conduits 216 can provide fluid flows between the flow regulator 214 and the pressure reducing elements 212. Each flow regulator 214 can selectively permit or inhibit the flow of fluid from the outlet 134 into the conduits 216 and into the mold apparatus 132. In one embodiment, the flow regulator 214 can be solenoid valve, either actuated electronically or pneumatically, to permit or inhibit the flow into the mold apparatus 132. In various other embodiments, the flow regulator 214 can be a gate valve, globe valve, or other suitable device that can control the flow of fluid. A controller (e.g., the controller 218 of FIG. 9) can command the flow regulator 214 to permit or inhibit the flow of fluid to the channels (e.g., channels 204 and/or 206). The flow regulator 214 can stop the flow of fluid through the mold apparatus 132 for intermittent fluid flow. Optionally, the flow regulator 214 can provide different fluid flow rates to each of the conduits 216.

Fluid from the conduits 216 passes through pressure reducing elements 212 and into the channels 204 in the mold apparatus 132. Although not shown, the outlet 134 can feed fluid directly to the pressure reducing elements 212. As discussed above, there can be a temperature drop across the pressure reducing elements 212. In the illustrated embodiment of FIG. 10, there is a pressure drop across the pressure reducing elements 212 so that the temperature of the fluid in channels (e.g., channels 204) is at or near a desired temperature. The temperature drop is preferably caused by a reduction in pressure across the pressure reducing elements 212.

As used herein, the term “high heat transfer material” is a broad term and is used in accordance with its ordinary meaning and may include, without limitation, low range, mid range, and high range high heat transfer materials. Low range high heat transfer materials are materials that have a greater thermal conductivity than iron. For example, low range high heat transfer materials may have a heat conductivity superior to iron and its alloys. High range high heat transfer materials have thermal conductivity greater than the mid range materials. For example, a material that comprises mostly or entirely copper and its alloys can be a high range heat transfer material. Mid range high heat transfer materials have thermal conductivities greater than low range and less than the high range high heat transfer materials. For example, AMPCOLOY® alloys, alloys comprising copper and beryllium, and the like can be mid range high heat transfer materials. In some embodiments, the high heat transfer materials can be a pure material (e.g., pure copper) or an alloy (e.g., copper alloys). Advantageously, high heat transfer materials can result in rapid heat transfer to reduce cycle times and increase production output. For example, the high heat transfer material at room temperature can have a thermal conductivity more than about 100 W/(mK), 140 W/(mK), 160 W/(mK), 200 W/(mK), 250 W/(mK), 300 W/(mK), 350 W/(mK), and ranges encompassing such thermal conductivities. In some embodiments, the high heat transfer material has a thermal conductivity 1.5 times, 2 times, 3 times, 4 times, or 5 times greater than iron.

To enhance temperature control, the temperature control elements can be used in combination with high heat transfer material. For example, one or more temperature control elements can be positioned near or within the high heat transfer material to maximize heat transfer between the mold surfaces and the temperature control elements. For example, the high heat transfer can form at least a substantial portion mold material interposed between the one or more temperature control elements and the molding surfaces.

If a post-cooling operation is utilized, demolding can be done at an earlier stage as structural stability of the molded article is primarily needed to withstand the mechanical forces during demolding. The structural stability molded article can be quickly demolded from the mold. At the moment of demolding, due to the chilling effect of the mold wall the peripheral layers of the molded article have already fallen to lower temperatures while the interior of the article is a soft liquid. For example, there can be a steep temperature rise between the periphery of the preform and the interior of the preform. The peripheral low temperature region of the polymer mechanically stabilizes the preform at demolding. The mechanical strength of the preform can therefore depend on the temperature gradient during the cooling process. For example, the cooled periphery of the preform (e.g., a cooled outer shell) depends, at least in part, on the peripheral temperature gradient. The peripheral temperature gradient is mainly a function of the mold surface temperature. A mold utilizing a high conductivity alloy and a cooling means, such as cold cooling fluid, can produce a low mold surface temperature, thus a steeper temperature gradient and therefore a mechanically stable “shell” faster than, e.g., a steel mold. Thus, the combination of high heat transfer material and a low temperature cooling fluid (e.g., refrigerants including cryogenic fluids) are especially useful for post-cooling processes.

The cavity section 192 comprising the high heat transfer material can provide high heat transfer rates that may not be achieved with traditional molds. Traditional molds are typically made of steel that is subjected to high thermal stresses upon rapid and large temperature changes. The thermal stresses may cause strain hardening of the steel and may dramatically reduce mold life. For example, cyclic thermal loading can cause fatigue which eventual compromises the structural integrity of the molds. Steel and some other typical mold materials may be unsuitable for the extreme temperature loads and thermal cycles. Thus, these materials may be unsuitable for use with refrigerants, such as cryogenic fluids. Copper has a high thermal conductivity and can undergo rapid temperature changes. However, copper is a relatively soft material that has a relatively low mechanical strength and hardness and, thus, may not be able to withstand high clamp forces experienced during molding processes. Also, if copper forms the molding surfaces, the copper can become worn and roughened after extended use and can result in improperly formed molded articles. However, some high heat transfer materials are much more suitable for rapid and large temperature changes while also having improved mold life. The high heat transfer materials can withstand cyclic thermal loading with limited amounts of damage due to fatigue. The high heat transfer materials can be hardened material for an improved life as compared to copper. Advantageously, the high heat transfer material can transfer heat at a higher rate than steel and other traditional mold materials. Thus, cycle times can be reduced due to the thermal properties of high heat transfer materials.

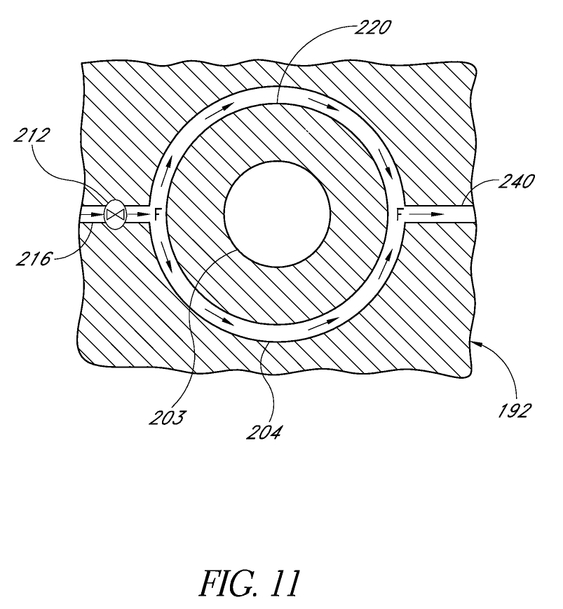

As illustrated in FIG. 10 and FIG. 11 (a partial side cross-sectional view of the cavity section 192), the channels 204 are generally annular channels, preferably substantially concentric with the cavity molding surface 203 to ensure that the thickness of the portion 220 between the cavity molding surface 203 and the channels 204 is substantially uniform. The heat transfer between the melt and the fluid in the channels can be increased by decreasing the distance between the channels 204 and the cavity molding surface 203. Those skilled in the art recognize that the channels 204 can have various shapes and sizes depending on desired heat distributions in the mold apparatus 132. In the illustrated embodiment, the channels 204 have a substantially circular cross-sectional profile. In other embodiments, the channels 204 can have a cross-sectional profile that is generally elliptical, polygonal (including rounded polygonal), or the like. In one embodiment, the cavity section 192 has less than about then about ten channels 204. In another embodiment, the cavity section 192 has less than about seven channels 204. In another embodiment, the cavity section 192 has less than about four channels 204. The number and placement of channels 204 can be selected for efficient cooling of the mold apparatus 132.

With reference to FIG. 11, fluid F flows from the conduit 216 through the pressure reducing element 212 and into the channel 204. The fluid F (preferably a two-phase flow) is split into two fluid flows and passes through the two semi-circular portions of the channel 204 towards the conduit 240. The fluid F then passes through the conduit 240 to the mold inlet 136 and into the fluid line 140. Heat is transferred between the fluid F in the channels 204 and the mold cavity section 192 because of the temperature difference between the fluid F and the walls of the channels 204. If the working fluid F is a two-phase flow, the liquid component of the flow can undergo a phase change become a gas as the fluid absorbs heat. Advantageously, the temperature of the fluid F can remain generally constant along the channels 204, so long as the fluid F comprise liquid.

If the temperature of the channels 204 is at a temperature higher than the temperature of the fluid in the channels 204, there will be heat transferred to the fluid F. Thus, the mold apparatus 132 can be cooled as heat is transferred to the fluid F. If the temperature of the fluid F in the channels 204 is higher than the temperature of the channels 204, heat will be transferred to the channels 204. The flow rate of the fluid F can be increased to increase the heat transfer between the fluid F and the mold apparatus 132.

With reference again to FIG. 10, the core section 194 can include a core 198 that is generally hollow. The core 198 has a wall 244 having a generally uniform thickness proximate to the neck portion 32 of the preform 30. The thickness of the wall 244 necks down to a distal portion having a generally uniform thickness. A temperature control arrangement 246 is disposed in the core 198 and comprises a core channel or tube 248 located centrally in the core 298 which preferably receives fluid F from the fluid line 130 and delivers fluid F directly to a base end 254 of the core 198. The fluid F passes through a pressure reducing element 260, preferably an expansion valve, and into a channel 208. In the illustrated embodiment, the channel 208 is defined by the outer surface of the core channel 248 and an inner surface 210 of the wall 244 of the core. The fluid F works its way up the core 198 from the base end 254 though the channel 208 and exits through an output line 270. In one embodiment, the fluid F in the core channel 248 is a liquid that is vaporized as it passes through the pressure reducing element 260. At least a substantial portion of the fluid in the channel 208 can be gas, preferably at a lower temperature than the temperature of the fluid in the core channel 248, to ensure that the core 198 is maintained at a suitable temperature. In some embodiments, the pressure reducing element is positioned outside of the core 198. Thus, a gas or two-phase flow can be delivered to the core channel 208.

Different fluids can be used to control the temperature of the cavity section 192 and the core section 194. In one embodiment, for example, the fluid line 130 can comprise two tubes where one of the tubes delivers CO₂ to the cavity section 192 and the other tube delivers N₂ to the core section 194. Thus, the temperature control systems can use multiple fluids to maintain desirable temperatures in the mold apparatus 132. In other embodiments, similar fluids can be used in the cavity section 192 and the core section 194. For example, CO₂ can be the working fluid in the cavity section 192 and the core section 194.

Pulse temperature control can be utilized to periodically heat or cool the mold apparatus 132. In some embodiments, pulse temperature control comprises pulse cooling. For pulse cooling, fluid cam be pulsed through the mold apparatus 132 for periodic temperature changes. When the moldable material is disposed in the mold apparatus 132, chilled fluid can circulate through the apparatus 132 to cool the polymer material. During the reduced flow period of pulse cooling, the flow of chilled fluid is substantially reduced or stopped. In one embodiment, the flow regulator 214 is controlled to stop the flow of fluid through the mold apparatus 132. The flow regulator 214 can independently stop or reduce the fluid flow into each of the conduits 216. In another embodiment, the valve 222 can be operated to stop or reduce the flow of the fluid through the mold apparatus 132.

The reduced flow period preferably corresponds to when the mold apparatus 132 is empty and/or during non-use of the mold apparatus 132 (e.g., during repair periods). For example, after the preform is at a desired temperature, the core section 194 and the cavity section 192 can be separated, as shown, for example, in FIG. 21, and the preform can be removed from the mold apparatus 132. While the core section 194 and cavity section 192 are separated, the flow rate of the fluid through the mold apparatus 132 is reduced to inhibit the formation of condensation on the surfaces of the mold. The flow of chilled fluid can be reduced before or after the core section 194 and the cavity section 192 are separated.

Advantageously, pulse cooling efficiently uses fluid from fluid source and can result in reduced cycle time and properly formed preforms. The temperature control system may be an open loop with a fluid source having a limited supply of fluid. The refrigerant is efficiently used during manufacturing periods that require heat transfer to the refrigerant, such as for cooling preforms. The frequency of replacing the fluid source is reduced because fluid is used for cooling the preform and is not used when, for example, the mold apparatus 132 is empty.

Accordingly, thermoplastic melt injected in the mold cavity can be cooled or heated by fluid circulating in channels 204 and 206 in the two halves of the mold. Preferably the circulation in channels 204 is completely separate from the circulation of fluid in the channels 206. Additionally, although not illustrated, cold water-bubblers can be used to cool the core 198 illustrated in FIG. 10. Additional disclosure regarding embodiments that comprise pressure-reducing elements and other temperature control systems and features for molds are disclosed in U.S. Pat. No. 7,303,387 titled METHODS AND SYSTEMS FOR CONTROLLING MOLD TEMPERATURES, the entirety of which is hereby incorporated by reference herein.

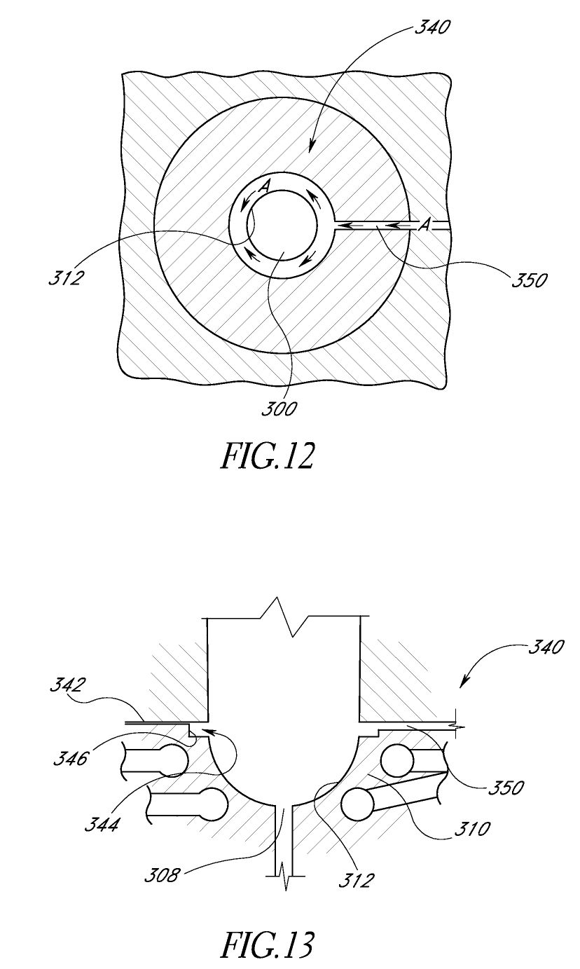

Referring to FIGS. 12 and 13, an air insertion system 340 is shown formed at a joint 342 between members of the mold cavity 300. A notch 344 is formed circumferentially around the cavity 300. The notch 344 is sufficiently small that substantially no molten plastic will enter during melt injection. An air line 350 connects the notch 344 to a source of air pressure and a valve regulates the supply of air to the notch 344. During melt injection, the valve is closed. When injection is complete, the valve is opened and pressurized air A is supplied to the notch 344 in order to defeat a vacuum that may form between an injected preform and the cavity wall 304. Additionally, similar air insertion systems 340 may be utilized in other portions of the mold, such as the thread area, for example but without limitation.

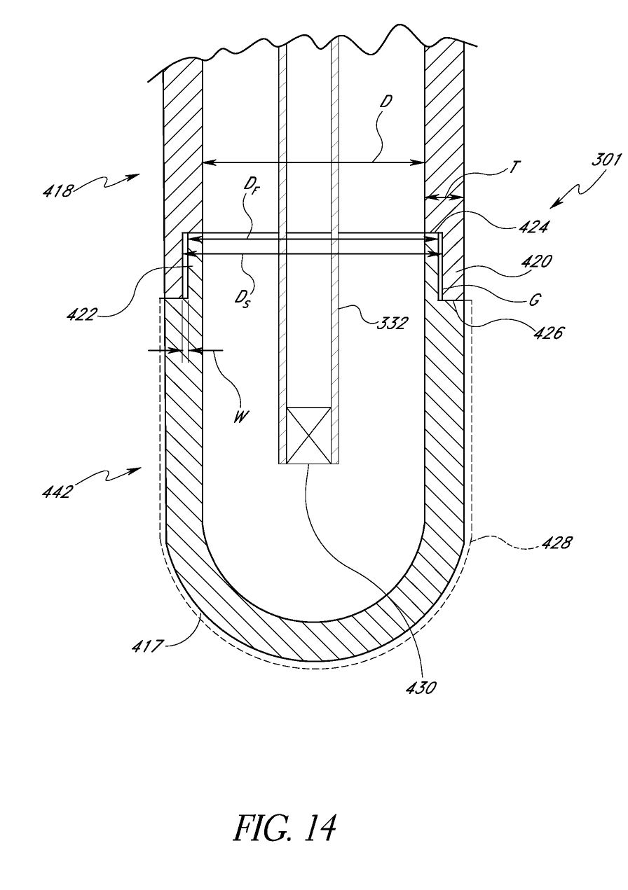

FIG. 14 is a schematic representation of one embodiment of a core 301, including a modified base end 417 or tip. As discussed herein, the end cap portion of the injection molded preform adjacent the base end 417, receives the last portion of the melt stream to be injected into the mold cavity 300. Thus, this portion is the last to begin cooling. If the PET or other substrate layer has not sufficiently cooled before the overmolding process takes place, the force of the overmolding material melt entering the mold may wash away some of the PET near the base end 417 of the core 301. To speed cooling in the base end 417 of the core in order to decrease cycle time, the modified core 301 can include a base end 442 portion constructed of an especially high heat transfer material, preferably a high heat transfer material, such as AMPCOLOY or other copper alloy. Advantageously, the AMPCOLOY base end 442 can allow the circulating fluid F to withdraw heat from the injected preform at a higher rate than the remainder of the core 301. Such a construction allows the end cap portion of the preform to cool quickly, in order to decrease the necessary cooling time and, thus, reduce the cycle time of the initial preform injection.

The modified core 301 illustrated in FIG. 14 generally comprises an upper core portion 418 and a base end portion 442—constructed of a high heat transfer material, including, but not limited to, a beryllium-free copper alloy, such as AMPCOLOY. A pressure reducing element 430 is at the distal end of the core channel 332, as described herein. Thus, the pressure reducing element 430 can be configured to provide a desired fluid pressure drop. Further, the core channel 332 can be configured to be operable for delivering circulating cooling fluid F to the base end 442 of the core 301. Additional disclosure of a mandrel or core having a modified base end or tip is provided in U.S. Pat. No. 7,303,387 titled METHODS AND SYSTEMS FOR CONTROLLING MOLD TEMPERATURES, the entirety of which is hereby incorporated by reference herein.

In the continuing effort to reduce cycle time, injected preforms can be removed from corresponding mold cavities as quickly as possible. However, in some embodiments, newly injected thermoplastic material may not necessarily be fully solidified when the injected preform is removed from the mold cavity. This can result in possible problems related to the removal of the preform from the cavity 300. Friction or even a vacuum between the hot, malleable plastic and the mold cavity surface 304 can cause resistance resulting in damage to the injected preform when an attempt is made to remove it from the mold cavity 300.

Typically, mold surfaces are polished and extremely smooth in order to obtain a smooth surface of the injected part. However, polished surfaces tend to create surface tension along those surfaces. This surface tension may create friction between the mold and the injected preform which may result in possible damage to the injected preform during removal from the mold. In some embodiments, in order to reduce surface tension, the mold surfaces are treated with a very fine sanding device to slightly roughen the surface of the mold. In some arrangements, the sandpaper has a grit rating between about 400 and 700. For example, in one configuration, a sandpaper grit rating of approximately 600 is used. Also, the mold can be sanded in only a longitudinal direction, further facilitating removal of the injected preform from the mold.

While some of the improvements to mold performance are discussed with reference to specific methods, devices and apparatuses herein, those of skill in the art will appreciate that such improvements and features may also be applied in many different types of plastic injection molding applications and associated devices and apparatuses, whether specifically discussed herein or not. For instance, use of a high heat transfer material in a mold may quicken heat removal and dramatically decrease cycle times for a variety of mold types and melt materials. Pulse cooling can be used to cool the cores, neck finish portion, and/or the cavity section of the mold. Also, roughening of the molding surfaces and provides air pressure supply systems may ease part removal for a variety of mold types and melt materials.

FIG. 15 illustrates one embodiment of an injection mold apparatus 500. The injection mold assembly 500 can be configured to produce a monolayer preform. In the illustrated arrangement, the mold 500 utilizes one or more hardened materials to define contact surfaces between various components of the mold 500. As used herein, the term “hardened material” is a broad term and is used in its ordinary sense and refers, without limitation, to any material which is suitable for preventing wear, such as tool steel. In various embodiments, the hardened or wear resistant material may comprise a heat-treated material, alloyed material, chemically treated material, or any other suitable material. The mold 500 also uses one or more materials having high heat transfer properties to define at least a portion of the mold cavity surfaces. The mold 500 may also utilize the hardened materials (having generally slower heat transfer properties) to produce a preform having regions with varying degrees of crystallinity, similar to other injection molds described herein. In some embodiments, the molds described herein can comprise a hardened high heat transfer material to reduce wear. For example, hardened copper and its alloys can have a hardness and/or strength properties (e.g., yield strength, ultimate tensile strength, and the like) greater than unhardened pure copper.

As with other mold arrangements disclosed herein, the depicted mold assembly 500 can include a core section 502 and a cavity section 504. The core section 502 and the cavity section 504 can define a parting line P, indicated generally by the dashed line of FIG. 15, between them. The core section 502 and the cavity section 504 cooperate to form a mold cavity 506, which is generally shaped according to the desired final shape of a preform or other moldable item being produced. In the illustrated embodiment, at least a portion of the mold cavity 506 is defined by a core molding surface 507 and a cavity molding surface 509. The cavity section 504 of the mold 500 can define a passage, or gate 508, which communicates with the cavity 506. An injection nozzle 510 delivers a molten polymer to the cavity 506 through the gate 508.

Preferably, the core section 502 of the mold 500 includes a core member 512 and a core holder 514. The core holder 514 is sized and shaped to be concentric about, and support a proximal end of, the core member 512. The core member 512 extends from an open end 516 of the core holder 514 and extends into the cavity section 504 of the mold to define an internal surface of the cavity 506 and thus, an internal surface of the final preform. The core member 512 and the core holder 514 include cooperating tapered portions 518, 520, respectively, which locate the core member 512 relative to the core holder 514.

In some embodiments, the core member 512 is substantially hollow, thus defining an elongated cavity 522 therein. A core channel or tube 524 can extend toward a distal end of the core cavity 522 to deliver a fluid, preferably a cooling fluid, to the distal end of the cavity 522. As in other arrangements disclosed herein, cooling fluid can be configured to pass through the core 524 and through a pressure reducing element 561, which can be similar to pressure reducing element 212. As a result, such cooling fluids can be delivered toward the end of the core member 512 and generally progress through the cavity 522 toward the base of the core member 512. The pressure reducing element 561 can provide a pressure drop in the working fluid similar to pressure reducing element 212 for vaporizing at least a portion of the working fluid. A plurality of tangs 526 can extend radially outward from the body of the tube 524 and contact the inner surface of the cavity 522 to maintain the tube 524 in a coaxial relationship with the core member 512. Such a construction can reduce or inhibit vibration of a distal end of the tube 524, thus improving the dimensional stability of the preforms produced by the mold 500.

In some arrangements, the cavity section 504 of the mold 500 includes a neck finish mold 528, a main cavity section 530 and a gate portion 532. All of these portions 528, 530, 532 cooperate to define an outer surface of the cavity 506, and thus an outer surface of the finished preform produced by the mold 500. The distal end of the core member 512 correlates to the distal end of the cavity 506. The neck finish mold 528 is positioned adjacent the core section 502 of the mold 500 and cooperates with the core section 502 to define the parting line P. The neck finish mold 528 defines the threads 534 and neck ring 536 portions of the cavity 506, and thus of the final preform. In some embodiments, the neck finish mold 528 comprises two semicircular portions that cooperate to define the neck finish mold of the cavity 506. This permits the neck finish mold 528 to be split apart from one another (e.g., in a plane perpendicular to the plane of separation between the core section 502 and cavity section 504) to permit removal of the finished preform from the cavity 506, as is known in the art.

The main cavity section 530 can define the main body portion of the cavity 506. Desirably, the main cavity section 530 can also define a plurality of temperature control elements in the form of channels 538, which are configured to direct fluid around the main body portion 530 in order to maintain the preform at a desired temperature or within a desired temperate range. Further, conduits 554 can comprise pressure reducing devices 558 as described herein.

With continued reference to FIG. 15, the mold 500 defines a number of contact surfaces defined between the various components that make up the mold 500. For example, in the illustrated arrangement, the core section 502, and specifically the core holder 514 defines a contact surface 542 that cooperates with a contact surface 544 of the cavity section 504 and, more specifically, the neck finish mold 528 of the mold 500. Similarly, the opposing side of the neck finish mold 528 defines a contact surface 546 that cooperates with a contact surface 548 of the main cavity section 530.

In some embodiments, the corresponding contact surfaces 542, 544 and 546, 548 intersect the mold cavity 506, and thus, it may be desirable to maintain a sufficient seal between the contact surfaces 542, 544 and 546, 548 in order to inhibit or reduce the likelihood that molten polymer within the cavity 506 enters between the respective contact surfaces. The corresponding contact surfaces 542, 544 and 546, 548 can preferably include mating tapered surfaces, generally referred to as taper locks. Due to the high pressure at which molten polymer is introduced into the cavity 506, a large clamp force is typically utilized to maintain the core section 502 and the cavity section 504 of the mold in contact with one another and maintain a good seal between the contact surfaces 542, 544 and 546, 548. As a result of such a high clamp force, it is desirable that the components of the mold 500 defining the contact surfaces are formed from a hardened material, such as tool steel, for example, to prevent excessive wear to these areas and increase the life of the mold.

Furthermore, as described in detail throughout the present application, at least a portion of the mold 500 that defines the cavity 506 can comprise one or more high heat transfer materials, such as AMPCOLOY. Such an arrangement permits rapid heat withdrawal from the molten polymer within the cavity 506, which cools the preform to a solid state so that the cavity sections 502 and 504 may be separated and the preform removed from the mold 500. As discussed, the rate of cooling of the preform is related to the cycle time that may be achieved without resulting in damage to the preform once it is removed from the mold 500.

A decrease in cycle time can mean that more parts may be produced in a given amount of time, therefore reducing the overall cost of each preform. However, high heat transfer materials that are preferred for at least portions of the molding surface of the cavity 506 are generally too soft to withstand the repeated high clamping pressures that exist at the contact surfaces 542, 544 and 546, 548, for example. Accordingly, if an entire mold were to be formed from a high heat transfer material, the relatively short life of such a mold may not justify the decrease in cycle time that may be achieved by using such materials. The illustrated mold 500 of FIG. 15, however, is made up of individual components strategically positioned such that the contact surfaces 542, 544 and 546, 548 comprise a hardened material, such as tool steel, while at least a portion of the mold 500 defining the cavity 506 comprises a high heat transfer material, to reduce cycle time.

In the illustrated embodiment, the core holder 514 is desirably constructed of a hardened material while the core member 512 is constructed from a high heat transfer material. Furthermore, the neck finish mold 528 of the mold desirably is constructed of a hardened material. The main cavity section 530 preferably includes a hardened material portion 530a and a high heat transfer material portion 530b. The hardened material portion 530a could be made from the same material the neck finish mold 528. The hardened material portion 530a could be made from a different material than the neck finish mold 528. Preferably, the hardened material portion 530a defines the contact surface 548 while the high heat transfer material portion 530b defines a significant portion of the mold surface of the cavity 506. The high heat transfer material portion 530b and the gate portion 532 may be made from the same or different material. The hardened material portion 530a and the high heat transfer material portion 530b of the main cavity section 530 may be coupled in any suitable manner, such as a silver soldering process as described above, for example. Furthermore, the gate portion 532 of the mold 500 is also desirably formed from a high heat transfer material, similar to the molds described herein.

In some embodiments, the neck finish mold 528 may or may not comprise a high heat transfer material. The illustrated neck finish mold 528 comprises a contact portion 802 coupled to an optional insert 801 (preferably a threaded insert configured to mold threads of a preform), which preferably comprises a high heat transfer material. In some arrangements, the contact portion 802 is positioned adjacent the core section 502 of the mold 500 and cooperates with the core section 502 to define the parting line P. Preferably, the contact portion 802 comprises one or more hardened materials, such as tool steel. The threaded insert 801 can define the threads 534 and the neck ring 536 portion of the cavity 506. The threaded inserts 801 can be coupled to the contact portion 802 and can comprise a high heat transfer material. The threaded insert 801 and the contact portion 802 can form a portion of the threads 534 and/or neck ring 536 and the proximal end of the cavity 506.

With a construction as described herein, the mold 500 can include hardened materials at the contact surfaces 542, 544 and 546, 548 to provide a long life to the mold 500. In addition, the mold 500 can also include high heat transfer materials defining at least a portion of the molding surfaces of the cavity 506 such that cycle times may be reduced, and therefore, through-put of the mold 500 can be increased accordingly. Such arrangements are especially advantageous in molds designed to form preforms, which, as is discussed in greater detail herein, can be later blow molded into a desired final shape.

Another benefit of such molds 500 is that the hardened material neck finish mold 528 includes a generally lower rate of heat transfer than the high heat transfer portions of the mold 500. Accordingly, the neck finish of the preform may become semi-crystalline or crystalline, which allows the neck finish to retain its formed dimensions during a hot-fill process. Furthermore, at least a portion of the core member 512 adjacent the neck finish mold 528 can comprise a high heat transfer material, which cools the inner surface of the thread finish of the preform relatively rapidly. As a result, the preform is permitted to maintain its formed dimensions when removed from the mold in a less than fully cooled state. By way of example, the cycle time may be reduced by 15%-30% utilizing a mold construction such as mold 500 in comparison with a mold made from conventional materials and construction techniques. In addition, certain portions of the mold 500 may be replaced, without necessitating replacement of the entire mold section. For example, the core member 512 and core holder 514 can be configured to be selectively replaced independently of one another. In the illustrated embodiment, the valves 558 or other pressure control (and/or flow control) devices can be easily replaced by removing the portions of the mold 500. After portions of the mold 500 are removed, the valves 558 can be configured to be exposed for convenient valve replacement. For example, the portion 530b can be removed from the mold apparatus 132 so that the pressure reducing element 558 is exposed for rapid replacement. In some embodiments, the pressure reducing elements 558 are expansion valves that can be inserted into the mold 500. Valves with different diameter orifices can be easily and rapidly replaced to produce various preforms comprising different materials. However, in other embodiments the pressure reducing elements 558 are built in the mold 500.

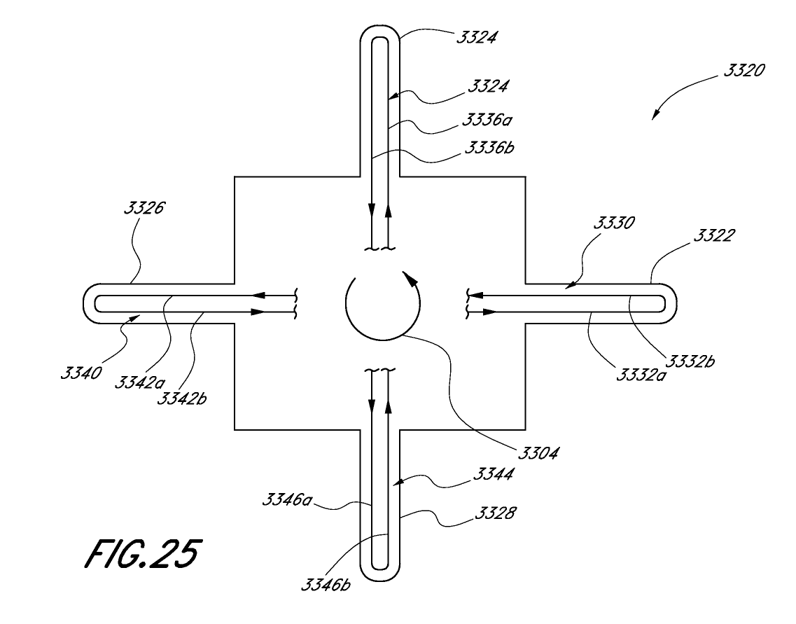

The mold 500 can be thermally insulated to reduce heat losses. Such illustrated molds 500 can include one or more portions 577 that comprise a low thermally conductivity material (e.g., tool steel) that surrounds the channels 538. The portion 577 can be a thermal barrier that reduces heat transfer between the mold 500 and the surrounding environment. The portion 577 can be a mold plate that holds various components of the mold. The portion 579 of the core section 502 can likewise comprise low thermally conductivity material to reduce thermal inefficiencies. Additional embodiments and disclosure regarding modified molds similar to the one illustrated in FIG. 15 are provided in U.S. Pat. No. 7,303,387 titled METHODS AND SYSTEMS FOR CONTROLLING MOLD TEMPERATURES, the entirety of which is hereby incorporated by reference herein. The various features, components and configurations disclosed within with reference to the use of hardened materials, separate core holder and core member portions, high heat transfer materials, pressure reducing valves and/or the like can be incorporated into any other embodiments described and/or illustrated herein, including those illustrated in FIGS. 24-27, or variations thereof.

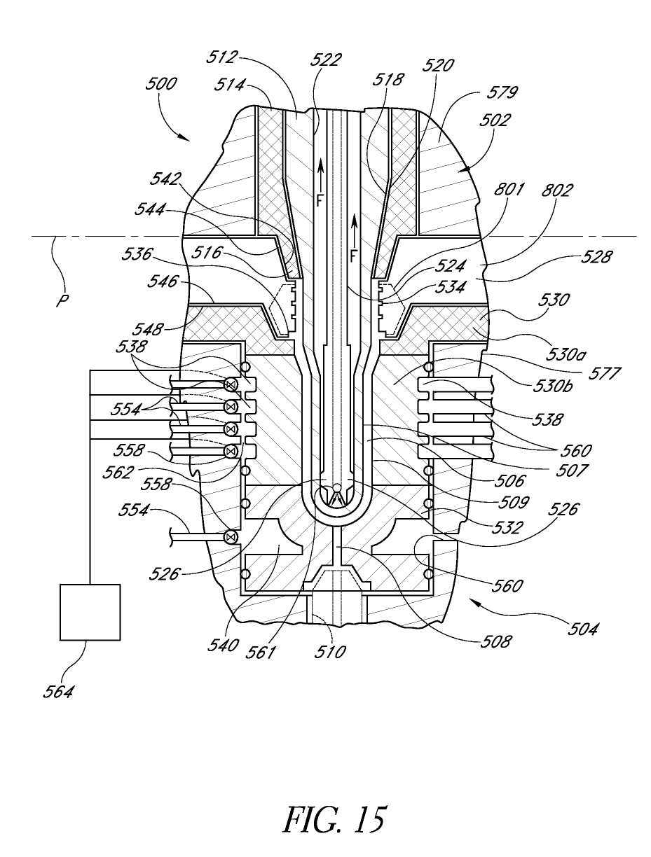

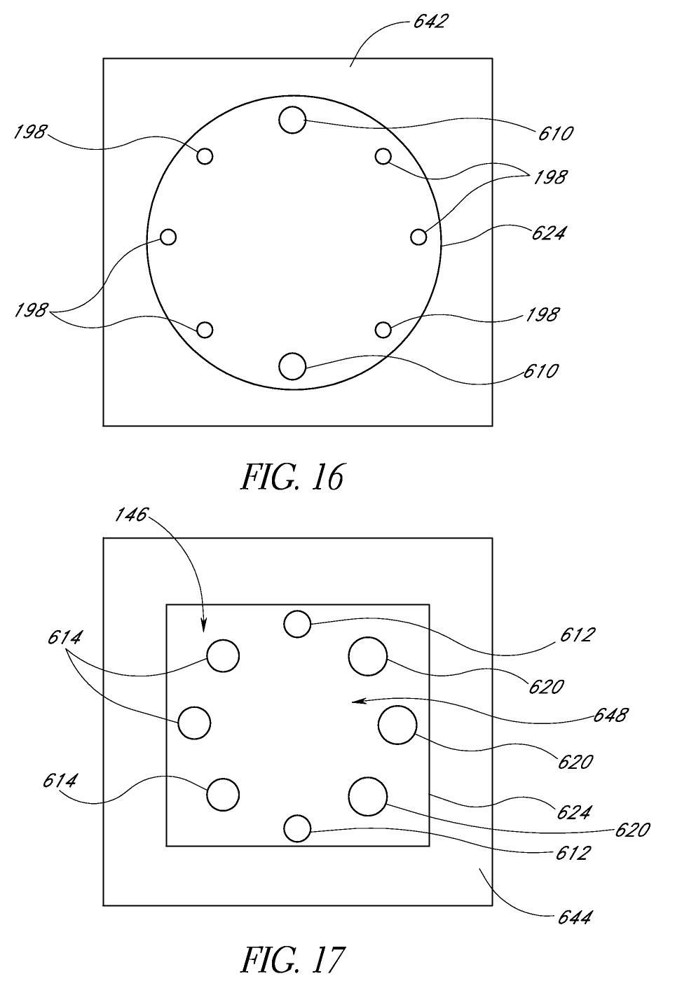

FIGS. 16 and 17 illustrate a portion of one embodiment of a molding apparatus adapted to make coated preforms. The apparatus can be an injection molding system designed to make one or more uncoated preforms and subsequently coat the newly-made preforms by over-injection of a material. As discussed herein, the preforms produced using such an apparatus or system can include one or more overmolding or coating layers. In some embodiments, such overmolding layers comprise PET, RPET, other virgin or non-virgin (e.g., recycled) polyesters or other thermoplastics. FIGS. 16 and 17 illustrate the two halves of the mold portion of the apparatus which will be in opposition in the molding machine. The alignment pegs 610 in FIG. 16 fit into their corresponding receptacles 612 in the other half of the mold.

The embodiment of the mold half depicted in FIG. 17 includes several pairs of mold cavities, each cavity being similar to other mold cavities disclosed herein. In some arrangements, the mold cavities are of two types: first injection preform molding cavities 614 and second injection preform coating cavities 620. The two types of cavities can be equal in number and can preferably be arranged so that all cavities of one type are on the same side of the injection block 624 as bisected by the line between the alignment peg receptacles 612. This way, every preform molding cavity 614 is 180° away from a preform coating cavity 620.

The mold half depicted in FIG. 16 includes several cores, such as core 198, one for each mold cavity (614 and 620). When the two halves illustrated in FIGS. 16 and 17 are mated or otherwise put together, a core 198 can fit inside each cavity and generally serve as the mold for the interior of the preform for the preform molding cavities 614 and as a centering device for the uncoated preforms in preform coating cavities 620. In the depicted arrangement, the cores 198 are mounted on a turntable 630 that is adapted to rotate 180° about its center so that a core 198 originally aligned with a preform molding cavity 614 will, after rotation, be aligned with a preform coating cavity 620, and vice-versa. As described in greater detail below, this type of setup can permit a preform to be molded and then coated in a two-step process using the same piece of equipment.

It should be noted that the drawings in FIGS. 16 and 17 are merely illustrative. For instance, the drawings depict an apparatus having three molding cavities 614 and three coating cavities 620 (a 3/3 cavity machine). However, the machines may have any number of cavities, as long as there are equal numbers of molding and coating cavities, for example 12/12, 24/24, 48/48 and the like. The cavities may be arranged in any suitable manner. These and other minor alterations are contemplated as part of this disclosure.

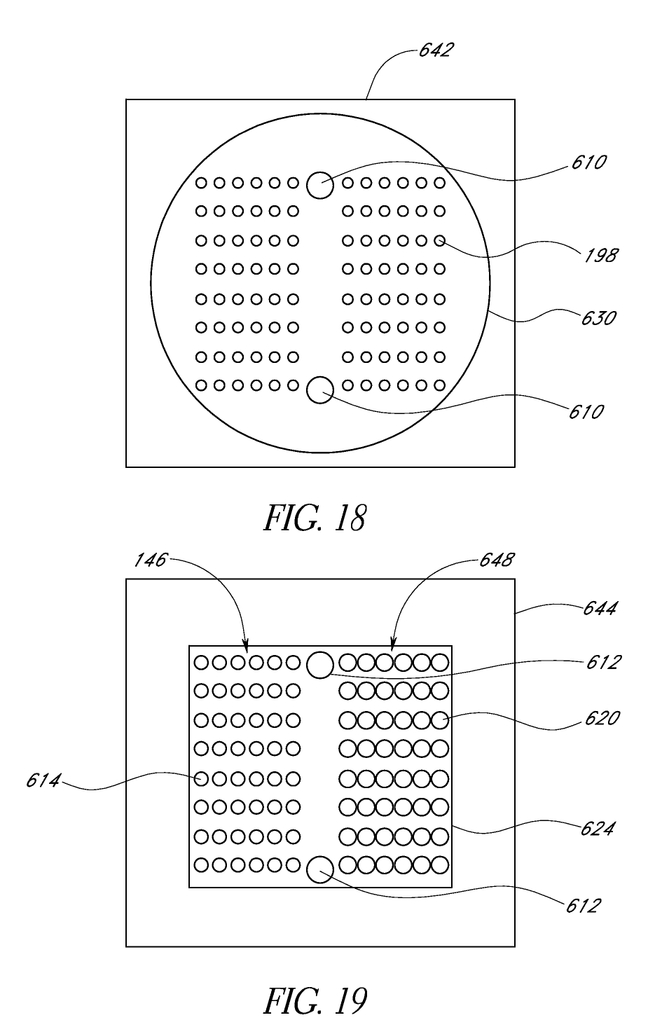

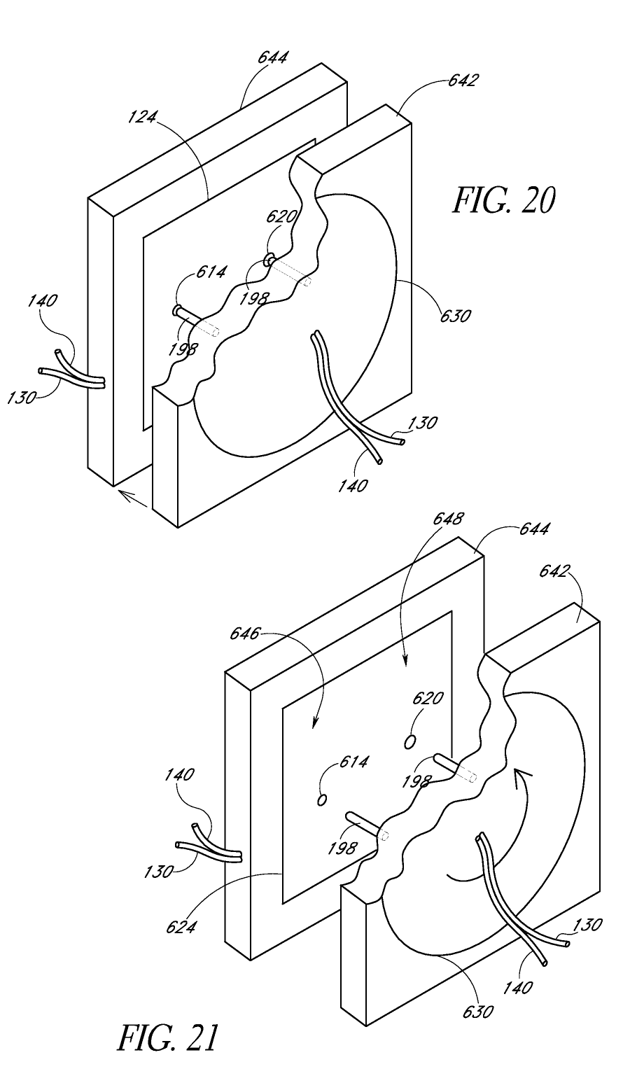

The two mold halves depicted in FIGS. 18 and 19 illustrate an embodiment of a mold of a 48/48 cavity machine. FIG. 20 illustrates a perspective view of a mold of the type for an overmolding (inject-over-inject) process in which the cores, such as cores 198, are partially located within the cavities 614 and 620. The arrow generally represents the movement of the movable mold half 642, on which the cores 198 lie, as the mold closes.

FIG. 21 shows a perspective view of a mold of the type used in an overmolding process, wherein the cores 198 are fully withdrawn from the cavities 614 and 620. When the cores 198 are fully withdrawn from the cavities 614, 620, moisture in the air may form condensation on one or more cavities if the temperature of the surface of the cavity is sufficiently low. The arrow indicates that the turntable 630 rotates 180° to move the cores 198 from one cavity to the next. In the illustrated embodiment, the fluid lines 130 and 140 rotate with the turntable 630. On the stationary half 644, the cooling for the preform molding cavity 614 can be separate from the cooling for the preform coating cavity 620. The fluid line 130 connected to the turntable 630 and the fluid line 130 connected to the stationary half 644 can be connected to the same fluid source or different fluid sources. Thus, the stationary half 644 and the turntable 630 can have independent temperature control systems, such as the temperature control system 120. The cooling of the cavities of the stationary half 644 can be separate from the cooling for the cores 198 in the movable half. Additional disclosure and embodiments of molding methods, devices and apparatuses for making multilayer preforms are provided herein.

1. Overmolding (Inject-Over-Inject) Processes

In some embodiments, overmolding is performed by using an injection molding process using equipment similar to that used to form the uncoated preform itself. One arrangement of a mold for overmolding with an uncoated preform in place is shown in FIG. 10. The depicted mold comprises two halves, a cavity section 192 and a core section 194, and is shown in FIG. 10 in the closed position prior to overinjecting. The cavity section 192 can comprise a cavity in which the uncoated preform is placed. Further, the support ring 38 of the preform can rest on a ledge 196 and may be held in place by the core section 194, which exerts pressure on the support ring 38, thus sealing the neck portion off from the body portion of the preform. In the illustrated embodiment, the cavity section 192 includes a plurality of tubes or channels 204 therein which carry a fluid as discussed herein. The fluid in the channels can be configured to circulate in a path in which the fluid passes into the cavity section 192, through the channels 204 and out of the cavity section 192. In a closed loop system, the fluid is passed back into the cavity section 192 after the fluid reaches a desired temperature. The circulating fluid serves to cool the mold, which in turn cools the plastic melt which is injected into the mold to form coated or uncoated preforms. Alternatively, as discussed herein, fluid can flow through an open loop system.

The core section 194 of the mold can comprise the core 198. The core 198, which is sometimes referred to as a mandrel, can be configured to protrude from the core section 194 of the mold and occupy the central cavity of the preform. In addition to helping to center the preform in the mold, the core 198 can help cool the interior of the preform. The cooling is done by fluid circulating through channels in the core section 194 of the mold, most importantly through the length of the core 198 itself. The channels 206 of the core section 194 work in a manner similar to the channels 204 in the cavity section 192, in that they create the portion of the path through which the cooling fluid travels which lies in the interior of the mold half.

As the preform sits in the mold cavity, the body portion of the preform is centered within the cavity and is completely surrounded by a void space 200. The preform, thus positioned, acts as an interior die core in the subsequent injection procedure. The melt of the overmolding material (e.g., PET, RPET, etc.) can then be introduced into the mold cavity from the injector via gate 202 so that it flows around the preform, preferably surrounding at least the body portion 34 of the preform. Following overinjection, the overmolded layer will take the approximate size and shape of the void space 200.

The coating material (e.g., RPET, PET, etc.) can be heated to form a melt of a viscosity compatible with use in an injection molding apparatus. The temperature for this, the inject temperature, will differ among materials, as melting ranges in polymers and viscosities of melts may vary due to. the history, chemical character, molecular weight, degree of branching and other characteristics of a material. In some embodiments, the inject temperature of the thermoplastics used in the overmolding layers is in the range of about 160-325° C. (e.g., 200-275° C.). However, the temperature of the thermoplastics injected into a mold cavity to form one or more overmolding or coating layers can be greater or less than indicated herein, as desired or required by a particular materials, application or use. The coating material is then injected into the mold in a volume sufficient to fill the void space 200.

In some embodiments, coated or multilayer preforms are cooled at least to the point where they can be displaced from the mold or handled without being damaged, and removed from the mold where further cooling may take place. In arrangements where PET or RPET is used, and the preform has been heated to a temperature near or above the temperature of crystallization for PET, cooling can be configured to be relatively rapid and sufficient to ensure that the PET or RPET is primarily in the semi-crystalline state when the preform is fully cooled. As a result of this process, a strong and effective bonding can occur between the initial preform layer and the subsequently applied coating or overmolding material.

Overmolding can be also used to create coated preforms with three or more layers. FIG. 5 illustrates a three-layer embodiment of a preform 72 in accordance with one embodiment. The depicted preform includes two coating layers, a middle layer 74 and an outer layer 76. The relative thickness of the layers shown in FIG. 5 may be varied to suit a particular combination of layer materials or to allow for the making of different sized bottles. As will be understood by one skilled in the art, a procedure analogous to that disclosed above would be followed, except that the initial preform would be one which had already been coated, as by one of the methods for making coated preforms described herein, including overmolding.

a. Method and Apparatus for Overmolding

Apparatuses and systems for containing molds disclosed herein (or equivalents thereof) and performing the overmolding process to create multilayer preforms include any injection molding machines that are known in the art, including those made by Husky, Engel, and the like. For example, one apparatus for performing the overmolding process is based upon the use of a 330-330-200 machine by Engel (Austria). A mold portion of such machines is shown schematically in FIGS. 16-21 and comprises a movable half 642 and a stationary half 644. In some embodiments, both halves are preferably made from hard metal. The stationary half 644 comprises at least two mold sections 146, 148, wherein each mold section comprises N (N>0) identical mold cavities 614, 620, an input and output for cooling fluid, channels allowing for circulation of cooling fluid within the mold section, injection apparatus, and hot runners channeling the molten material from the injection apparatus to the gate of each mold cavity. Because each mold section forms a distinct preform layer, and each preform layer is preferably made of a different material, each mold section is separately controlled to accommodate the potentially different conditions required for each material and layer. The injector associated with a particular mold section injects a molten material, at a temperature suitable for that particular material, through that mold section's hot runners and gates and into the mold cavities. The mold section's own input and output for cooling fluid allow for changing the temperature of the mold section to accommodate the characteristics of the particular material injected into a mold section. Different cooling fluids can be used in different channels within the mold for proper temperature distributions. Further, although not illustrated, the distance between the cavity mold surface and the each of the channels can be different. Similarly, the distance between the cavity mold surface and the valves (e.g., pressure reducing elements) can be different. Consequently, each mold section may have a different injection temperature, mold temperature, pressure, injection volume, cooling fluid temperature, etc. to accommodate the material and operational requirements of a particular preform layer.

In some embodiments, the movable half 642 of the mold comprises a turntable 630 and a plurality of cores 198. The alignment pins guide the movable half 642 to slidably move in a horizontal direction towards or away from the stationary half 644. The turntable 630 may rotate in either a clockwise or counterclockwise direction, and is mounted onto the movable half 642. The plurality of cores 198 are affixed onto the turntable 630. These cores 198 serve as the mold form for the interior of the preform, as well as serving as a carrier and cooling device for the preform during the molding operation. The cooling system in the cores is separate from the cooling system in the mold sections.

The mold temperature or cooling for the mold can be at least partially controlled by circulating fluid. The flow rate of fluid can be varied depending on the stage of the preform production. In some embodiments, there is separate cooling fluid circulation for the movable half 642 and for the overmolding section 648 of the stationary half 644. Additionally, the initial preform mold section 646 of the stationary half 644 can comprises two or more separate cooling fluid circulation systems (e.g., one for the non-crystalline regions, one for the crystalline regions, etc.). Cooling fluid can enter the mold, flow through a network of channels or tubes inside as discussed herein, and then exit through an output (e.g., mold inlet 136). From the output, the fluid can travel through a temperature control system before going back into the mold. In another embodiment, the fluid exits out the temperature control system by passing out of an exhaust system.

In some embodiments, the cores and cavities comprise a high heat transfer material, such a beryllium, which is coated with a hard metal, such as tin or chrome. The hard coating can help reduce or prevent direct contact between the beryllium or other high heat transfer material and the preform. In addition, such a hard coating can act as a release for ejection and providing a hard surface for long life. As discussed, the use of high heat transfer materials can allow for more efficient cooling, and thus assist in achieving lower cycle times. High heat transfer materials may be disposed over the entire area of each core and/or cavity, or only along selected portions thereof. In some embodiments, at least the tips of the cores comprise high heat transfer material. In other embodiments, the high heat transfer material is AMPCOLOY, which is commercially available from Uudenholm, Inc. The temperature control system can employ pulse cooling to cool the cavity and/or core while limiting the formation of condensation on the surfaces of the high heat transfer material.

In some embodiments, the number of cores of a molding system is equal to the total number of cavities, and the arrangement of the core 198 on the movable half 642 mirrors the arrangement of the cavities 614, 620 on the stationary half 644. To close the mold, the movable half 642 moves towards the stationary half 644, mating the core 198 with the cavities 614, 620. To open the mold, the movable half 642 moves away from the stationary half 644 such that the cores 198 are well clear of the block on the stationary half 644. After the cores are fully withdrawn from the mold sections 646, 648, the turntable 630 of the movable half 642 rotates the cores 198 into alignment with a different mold section. Thus, the movable half rotates 360°/(number of mold sections in the stationary half) degrees after each withdrawal of the cores from the stationary half. When the machine is in operation, during the withdrawal and rotation steps, there will be preforms present on some or all of the cores. As discussed in greater detail herein with reference to the embodiments of FIGS. 24-27, a molding apparatus or system can include one or more other configurations for producing multilayer preforms or other moldable items.

In some arrangements, the size of the cavities in a given mold section 646, 648 will be identical or substantially identical. However the size of the cavities can differ among the mold sections. For example, the cavities in which the uncoated preforms are first molded, the preform molding cavities 614, are smallest in size. The size of the cavities 620 in the mold section 648 in which the first coating step is performed are larger than the preform molding cavities 614, in order to accommodate the uncoated preform and still provide space for the coating material (e.g., RPET, PET, etc.) to be injected to form the overmolding coating. The cavities in each subsequent mold section wherein additional overmolding steps are performed can be increasingly larger in size to accommodate the preform as it gets larger with each overmolding or coating step.

After a set of preforms has been molded and overmolded to completion, a series of ejectors can be used to eject or otherwise remove the finished preforms off of the respective cores 198. In some embodiments, the ejectors for the cores operate independently, or at least there is a single ejector for a set of cores equal in number and configuration to a single mold section, so that only the completed preforms are ejected. Uncoated or incompletely-coated preforms remain on the cores so that they may continue in the cycle to the next mold section. The ejection may cause the preforms to completely separate from the cores and fall into a bin or onto a conveyor. Alternatively, as discussed with reference to the embodiments of FIGS. 24-27, the preforms may remain on the cores after ejection, after which a robotic arm or other such apparatus grasps a preform or group of preforms for removal to a bin, conveyor, or other desired location.

FIGS. 16 and 17 illustrate another embodiment of a molding apparatus. FIG. 17 illustrates the stationary half 644 of a mold. In this embodiment, the block 624 includes two mold sections, one section 646 comprising a set of three preform molding cavities 614 and the other section 648 comprising a set of three preform coating cavities 620. Each of the preform coating cavities 620 can be similar to that shown in FIG. 10 discussed above. Each of the preform molding cavities 614 can be similar to other embodiments illustrated and/or discussed herein, in that the moldable material is injected into a space defined by the core 198 (albeit without a preform already thereon) and the wall of the mold which is cooled by fluid circulating through channels inside the mold block. Consequently, one full production cycle of this apparatus will yield three two-layer preforms. If more than three preforms per cycle are desired, the stationary half can be reconfigured to accommodate more cavities in each of the mold sections. An example of this is seen in FIG. 19, wherein there is shown a stationary half of a mold comprising two mold sections, one mold section 646 comprising forty-eight preform molding cavities 614 and the other mold section 648 comprising forty-eight preform coating or overmolding cavities 620. If a three or more layer preform is desired, the stationary half 644 can be reconfigured to accommodate additional mold sections, one for each preform layer

FIG. 16 illustrates the movable half 642 of the mold. In the illustrated arrangement, the movable half comprises six identical cores 198 mounted on the turntable 630. Each core 198 corresponds to a cavity on the stationary half 644 of the mold. The movable half also comprises alignment pegs 610, which correspond to the receptacles 612 on the stationary half 644. When the movable half 642 of the mold moves to close the mold, the alignment pegs 610 are mated with their corresponding receptacles 612 such that the molding cavities 614 and the coating cavities 620 align with the cores 198. After alignment and closure, half of the cores 198 are centered within preform molding cavities 614 and the other half of the cores 198 are centered within preform coating cavities 620.

The configuration of the cavities, cores, and alignment pegs and receptacles are preferably configured with sufficient symmetry such that after the mold is separated and rotated the proper number of degrees, all of the cores generally line up with cavities and all alignment pegs generally line up with receptacles. Moreover, each core can be configured to be in a cavity in a different mold section than it was in prior to rotation in order to achieve the orderly process of molding and overmolding in an identical fashion for each preform made in the machine.

Two views of two mold halves together according to one embodiment are shown in FIGS. 20 and 21. In FIG. 20, the movable half 642 is moving towards the stationary half 644, as indicated by the arrow. Two cores 198, mounted on the turntable 630, are beginning to enter cavities, one enters a molding cavity 614 and the other is entering a coating cavity 620 mounted in the block 624. In FIG. 21, the cores 198 are fully withdrawn from the cavities on the stationary side. The preform molding cavity 614 comprises two cooling circulation systems which are separate from the cooling circulation for the preform coating cavity 620, which comprises the other mold section 648. The two cores 198 are cooled by a single system that links all the cores together. The turntable 630 could also rotate clockwise. Not shown are coated and uncoated preforms which would be on the cores if the machine were in operation. The alignment pegs and receptacles have also been left out for the sake of clarity.

The operation of an overmolding apparatus will be discussed in terms of the two mold section apparatus illustrated in FIGS. 20 and 21 for making a two-layer preform. However, it will be appreciated that is simply one non-limiting embodiment of producing multilayer preforms. The mold is closed by moving the movable half 642 towards the stationary half 644 until they are in contact. A first injection apparatus injects a melt of first material (e.g., PET) into the first mold section 146, through the hot runners and into the preform molding cavities 614 via their respective gates to form the uncoated preforms each of which become the inner layer of a coated preform. The first material fills the void between the preform molding cavities 614 and the cores 198. Simultaneously, a second injection apparatus injects a melt of second material (e.g., RPET) into the second mold section 648 of the stationary half 644, through the hot runners and into each preform coating cavity 620 via their respective gates, such that the second material fills the void (200 in FIG. 17) between the wall of the coating cavity 620 and the uncoated preform mounted on the core 198 therein.

During this process, cooling fluid can be continuously or intermittently circulated through one or more portions or =areas of the core and/or cavity sections, as desired or required. Thus, the melts and preforms can be selectively cooled in the center by the circulation of cooling fluid in the movable half that goes through the interior of the cores, as well as on the outside by the circulation in each of the cavities. It will be appreciated that in other embodiments the size, shape, location, spacing and/or other characteristics of the cooling channels or other temperature regulating devices can vary.

The movable half 642 can then slide back to separate the two mold halves and open the mold until all of the cores 198 having preforms thereon are completely withdrawn from the preform molding cavities 614 and preform coating cavities 620. The ejectors eject the coated, finished preforms off of the cores 198 which were just removed from the preform coating cavities. As discussed, the ejection may cause the preforms to completely separate from the cores and fall into a bin or onto a conveyor, or if the preforms remain on the cores after ejection, a robotic arm or other apparatus may grasp a preform or group of preforms for removal to a bin, conveyor, or other desired location. The turntable 630 then rotates 180° so that each core 198 having an uncoated preform thereon is positioned over a preform coating cavity 620, and each core from which a coated preform was just ejected is positioned over a preform molding cavity 614. In some embodiments, rotation of the turntable 630 may occur as quickly as 0.5-0.9 seconds. Using the alignment pegs 610, the mold halves again align and close, and the first injector injects the first material (e.g., PET) into the preform molding cavity 614 while the second injector injects a second material (e.g., RPET) into the preform coating cavity 620.

A production cycle of closing the mold, injecting the melts, opening the mold, ejecting finished multilayer preforms, rotating the turntable, and closing the mold is repeated, so that preforms can be continuously molded and overmolded in accordance with the methods disclosed herein.

In some embodiments, when the apparatus first begins operating, e.g., during the initial cycle, no preforms are yet in the preform coating cavities 620. Therefore, the operator should either prevent the second injector from injecting the second material into the second mold section during the first injection, or allow the second material to be injected and eject and then discard the resulting single layer preform comprised solely of the second material. After this start-up step, the operator may either manually control the operations or program the desired parameters such that the process is automatically controlled.

Multilayer (e.g., two-layer) preforms can be made using any overmolding apparatus described herein or variations thereof. In some embodiments, the two layer preform comprises an inner layer comprising polyester (e.g., PET) and an outer layer comprising PET, RPET (e.g., pre-consumer, post-consumer, regrind and/or recycled PET), other recycled materials, barrier materials, foam, polyesters, other materials or combinations thereof. In some embodiments, the inner layer comprises virgin PET. In some embodiments, two layer preforms include an inner layer of virgin PET, in which the neck portion is generally crystalline or semi-crystalline and the body portion is generally non-crystalline. However, in other arrangements, the degree of crystallization of one or more portions of a multilayer preform can be varied as desired or required by a particular application or use. The following description is generally directed toward describing the formation of a single set of coated or multilayer preforms 60 of the type seen in FIG. 4. As such, a set of preforms will be followed through the process of molding, overmolding and ejection. The process described is directed toward preforms having a total thickness in the wall portion 66 of about 3 mm, comprising about 2 mm of virgin PET and about 1 mm of overmolding material. However, in other embodiments, the thickness of the overmolding or coating layer can be thicker than the inner layer (e.g., virgin PET). In addition, the thickness of the two layers can vary in other portions of the preform 60, as shown in FIG. 4.

It will be apparent to one skilled in the art that some of the parameters detailed below will differ if other embodiments of preforms are used. For example, the amount of time which the mold stays closed will vary depending upon the wall thickness of the preforms.

The apparatus described above is set up so that the injector supplying the mold section 646 containing the preform molding cavities 614 is fed with virgin PET and that the injector supplying the mold section 648 containing the preform coating cavities 620 is fed with a PET, RPET, a barrier material and/or the like.

The movable half 642 of the mold is moved so that the mold is closed. A melt of virgin PET is injected through the back of the block 624 and into each preform molding cavity 614 to form an uncoated preform 30 which becomes the inner layer of the coated preform. The injection temperature of the PET melt is preferably 250 to 320° C., more preferably 255 to 280° C. The mold is kept closed for preferably 1 to 10 seconds, more preferably 2 to 6 seconds while the PET melt stream is injected and then cooled by the coolant circulating in the mold.

In the first step, the PET substrate is injection molded by injecting molten PET into the cavities formed by the molds and cores in the mold stack. When the cavity is filled, the resin in the body portion will come into contact with cooling surfaces and the resin in the neck finish will come into contact with the heated thread mold. As the PET in the neck finish cools, it will begin to crystallize as a result of this contact with the relatively hot mold. Once in contact, the crystallization will start and continue at a rate determined by time and temperature. When the neck finish portions of the molds are kept above the minimum temperature of crystallization of the PET used, crystallization will begin on contact. Higher temperatures will increase the rate of crystallization and decrease the time required to reach the optimum level of crystallization while maintaining post mold dimensional stability of the neck finish of the preform. At the same time the resin in the neck finish portion is cooling into a crystallized state, the resin in the body portion or lower body portion of the preform will be in contact with the chilled portions of the mold and thus cooled into an amorphous or semi-crystalline state.

The movable half 642 of the mold is then moved so that the two halves of the mold are separated at or past the point where the newly molded preforms, which remain on the cores 198, are clear of the stationary side 644 of the mold. When the cores 198 are clear of the stationary side 644 of the mold, the turntable 630 then rotates 180° so that each core 198 having a molded preform thereon is positioned over a preform coating cavity 620. Thus positioned, each of the other core 198 which do not have molded preforms thereon, are each positioned over a preform molding cavity 614. The mold is again closed. Preferably the time between removal from the preform molding cavity 614 to insertion into the preform coating or overmolding cavity 620 is 1 to 10 seconds, and more preferably 1 to 3 seconds.

When the molded preforms are first placed into preform overmolding cavities 620, the exterior surfaces of the body portions of the preforms are not in contact with a mold surface. Thus, the exterior skin of the body portion is still softened and hot as described above because the contact cooling is only from the core inside. The high temperature of the exterior surface of the uncoated preform (which forms the inner layer of the coated preform) aids in promoting adhesion between the initial PET layer and the overmolding layers (e.g., RPET) injected over the initial layer to form the finished coated preform. In some embodiments, the surfaces of the materials are more reactive when hot, and thus chemical interactions between the overmolding or coating material (e.g., PET, RPET, barrier material, etc.) and the virgin PET may be enhanced by the high temperatures. Accordingly, the overmolding or coating material can coat and adhere to the initial layer of the preform with a cold surface. Thus the operation may be performed using a cold initial uncoated preform, but the adhesion between adjacent thermoplastic layers is markedly better when the overmolding process is done at an elevated temperature, as occurs immediately following the molding of the uncoated preform. As discussed, in some embodiments, the neck portion of the preform can be crystallized from the separated, thermally isolated cooling fluid systems in the preform molding cavity. Since the coating operation does not place material on the neck portion, its crystalline structure is substantially undisturbed. However, the neck portion of the preform can also be amorphous or partially crystalline, as desired or required. In some embodiments, the preform may have a hardened or egg-shell outer layer that surrounds a soft interior of the preform. The overmolding material can be selected to achieve the desired interaction between the substrate and the overmolded layer.

A second injection operation then follows in which a melt of a material (e.g., PET, RPET, other recycled melt, barrier melt, polypropylene melt, foam melt, etc.) is injected into each preform coating cavity 620 to coat the preforms. The temperature of the melt of polymer material is preferably 160 to 325° C. The exact temperature range for any individual overmolding material (e.g., RPET) can depend upon the specific characteristics of that material, but it is well within the abilities of one skilled in the art to determine a suitable range by routine experimentation given the disclosure herein. For example, if BLOX 0005 or BLOX 0003 is used, the temperature of the melt (inject temperature) is preferably 160 to 260° C., more preferably 200 to 240° C., and most preferably 175 to 200° C. During the same time that this set of preforms are being overmolded with polymer material in the preform coating cavities 620, another set of uncoated preforms is being molded in the preform molding cavities 614 as described above.

The two halves of the mold are again separated preferably 3 to 10 seconds, more preferably 4 to 6 seconds following the initiation of the injection step. The preforms which have just been coated or overmolded in the preform coating cavities 620 are ejected from the cores 198. The uncoated preforms which were just molded in preform molding cavities 614 remain on their cores 198. The turntable 630 is then rotated 180° so that each core having an uncoated preform thereon is positioned over a coating cavity 620 and each core 98 from which a coated preform was just removed is positioned over a molding cavity 614.

The cycle of closing the mold, injecting the materials, opening the mold, ejecting finished preforms, rotating the turntable, and closing the mold is repeated, so that preforms are continuously being molded and overmolded. Those of skill in the art will appreciate that dry cycle time of the apparatus may increase the overall production cycle time for molding a complete preform.

The process using modified molds and chilled cores can selectively produce unique combinations of amorphous/crystalline properties on the preforms or other moldable items being produced. As the core is chilled and the thread mold is heated, the thermal transfer properties of the PET act as a barrier to heat exchange. The heated thread molds crystallize the PET at the surface of the thread finish, and the PET material transitions into an amorphous form near the core as the temperature of the PET reduces closer to the core. This variation of the material from the inner (core) portion to the outer (thread) portion is also referred to herein as the crystallinity gradient.

For those embodiments in which some degree to crystallinity is desired in one or more portion of a preform, the core temperature and the rate of crystallization of the resin can play a part in determining the depth of crystallized resin. In addition, an amorphous inner surface of a preform portion (e.g., the neck finish) can stabilizes the post mold dimensions allowing closer molding tolerances than other crystallizing processes. On the other side, a crystallized outer surface can be configured to support an amorphous structure during high temperature filling of the container. Physical properties of a preform, container or other item can be additionally enhanced (e.g. brittleness, impact etc.) as a result of a unique crystalline/amorphous structure.

For those embodiments in which some degree to crystallinity is desired, an desirable or optimum temperature for crystallization may vary depending upon factors including resin grade, resin crystallization temperature, intrinsic viscosity, wall thickness, exposure time, mold temperature and/or the like. Resins can include PET homopolymer and copolymers (including but not limited to high-IPA PET, Copolyester Barrier Materials, and copolymers of PET and polyamides) and PEN. Such resins can have low intrinsic viscosities and moderate melt temperatures, e.g., having IVs of about 74 is 86, and melt temperatures of about 220-300° C. In some embodiments, a desired mold temperature range for PET is from about 240-280° C., with the maximum or desired crystallization rate occurring at about 180° C., depending upon the above factors, the preferred exposure time range is from about 20 to 60 seconds overall, which includes both injection steps in inject-over-inject embodiments, and the preferred injection cavity pressure range is about 5000 to 22000 PSI. Thicker finish wall thickness will require more time to achieve a particular degree of crystallinity as compared to that needed for a thinner wall thickness. Increases in exposure time (time in mold) will increase the depth of crystallinity and the overall percentage of crystallinity in the area, and changes in the mold temperature in the region for which crystallinity is desired will affect the crystallinity rate and dimensional stability.

One of the many advantages of using a process as disclosed herein is that the cycle times for the process can be similar to those for standard processes used to produce uncoated preforms. That is, the molding and coating of preforms by this process is done in a period of time similar to that required to make uncoated PET preforms of similar size by standard methods currently used in preform production. Therefore, one can make multilayer PET preforms instead of uncoated PET preforms without a significant change in production output and capacity.

If a PET or other thermoplastic melt cools relatively slowly, the PET may take on a generally crystalline form. Because crystalline polymers do not blow mold as well as amorphous polymers, a preform having a body portion of crystalline PET may not perform as well in forming containers as one having a body portion formed of PET having a generally non-crystalline form. If, however, the body portion is cooled at a rate faster than the crystal formation rate, as is described herein, crystallization of the PET can be decreased or minimized, and the PET may take on an amorphous or semi-crystalline form. Thus, sufficient cooling of the PET in the body portion of the preform is crucial to forming preforms which will perform as needed when processed.

The rate at which a layer of PET cools in a mold such as described herein can be, at least in part, proportional to the thickness of the layer of PET, as well as the temperature of the cooling surfaces with which it is in contact. If the mold temperature factor is held substantially constant, a thick layer of PET generally cools more slowly than a thin layer. This is because it takes a longer period of time for heat to transfer from the inner portion of a thick PET layer to the outer surface of the PET which is in contact with the cooling surfaces of the mold than it would for a thinner layer of PET because of the greater distance the heat must travel in the thicker layer. Thus, a preform having a thicker layer of PET needs to be in contact with the cooling surfaces of the mold for a longer time than does a preform having a thinner layer of PET. In other words, with all things being equal, it may take longer to mold a preform having a thick wall of PET than it takes to mold a preform having a thin wall of PET. Temperature control systems with the valves proximate to the preform can be used to enhance the cooling of preforms in order to decrease or minimize the cooling time for thick wall or thin wall PET.

One advantage gained by a thinner preform can be taken a step farther if a preform made in the process is of the type in FIG. 4. In this embodiment of a coated preform, the PET wall thickness at 70 in the center of the area of the end cap 42 is reduced to preferably about ⅓ of the total wall thickness. Moving from the center of the end cap out to the end of the radius of the end cap, the thickness gradually increases to preferably about ⅔ of the total wall thickness, as at reference number 68 in the wall portion 66. The wall thickness may remain constant or it may, as depicted in FIG. 4, transition to a lower thickness prior to the support ring 38. The thickness of the various portions of the preform may be varied, but in all cases, the PET and the overmolding layer wall thicknesses can remain above critical melt flow thickness for any given preform design.

Using preforms 60 of the design in FIG. 4 allows for even faster cycle times than that used to produce preforms 50 of the type in FIG. 3. As discussed herein, one of the biggest obstacles to reducing mold cycle times is the length of time that the PET needs to be cooled in the mold following injection. If the body portion of a preform comprising PET has not sufficiently cooled before it is ejected from the core, it will become substantially crystalline and potentially cause difficulties during blow molding. Furthermore, if the PET layer has not cooled enough before the overmolding process takes place, the force of the coating or overmolding material (e.g., RPET) entering the mold may wash away some of the PET near the gate area. The preform design in FIG. 4 takes care of both problems by making the PET layer thinnest in the center of the end cap region 42, which is where the gate is in the mold. The thin gate section allows the gate area to cool more rapidly, so that the uncoated PET layer may be removed from the mold in a relatively short period of time while still avoiding crystallization of the gate area and washing of the PET during the second injection or overmolding phase.

### D. Formation of Preferred Containers by Blow Molding

As discussed herein, plastic containers can be produced by blow-molding preforms. The mold 80 of FIG. 6 can comprise one or more temperature control systems 710. The illustrated mold 80 comprises a blow mold neck portion 706 and a blow mold body portion 708. The temperature control system 710 can comprise a single or multi circuit system. The illustrated temperature control system 710 comprises a plurality of temperature control elements in the form of channels 712, 714, although other temperature control elements can be used. The fluid circulation in the channels 712 is preferably independent from the fluid circulation in the channels 714. The channels 712 pass through the blow mold neck portion 706, and the channels 714 pass through the blow mold body portion 708. However, the channels can be at any suitable location for controlling the temperature of the blow molded container. The blow mold temperature control system can also comprise heating/cooling rods, electric heaters, and the like.

The mold 80 can comprise high heat transfer material to rapidly cool the molded container, thus reducing the amount of chilled air (e.g., food grade air) used to reduce the temperature of the container, although chilled air can be blown into the container to further reduce the temperature of the container. For example, at least a portion of the blow molding interior surface 718 can comprise high heat transfer material. In some embodiments, high heat transfer material form at least about 10%, 40%, 60%, 80%, 90% and ranges encompassing these amounts of the interior surface. In some embodiments, the entire interior surface 718 comprises high heat transfer material. The high heat transfer material can rapidly change the temperature of the blow molded container when the container contacts the interior surface 718.

The blow mold 80 can be substituted with the molding apparatuses of the temperature control systems described herein. As such, various configurations of fluid systems and working fluids can be employed with blow molds. Additionally, one or more pressure reducing elements can be in fluid in communication with the fluid channels 712, 714. The pressure reducing elements can vaporize an effective amount of refrigerant (e.g., cryogenic fluids), other coolants and/or other fluids (e.g., non-cryogenic liquids or gases) to reduce the temperature of such fluids such that the fluids can sufficiently cool the blow molded container within the mold cavity. Once the container contacts the interior surface 718, the wall of the blown container can be quickly cooled to form a dimensionally stable wall of the container.

In other embodiments in which it is desired for the entire container to be heat-set, the containers may be blow-molded in accordance with processes generally known for heat set blow-molding, including, but not limited to, those which involve orienting and heating in the mold, and those which involve steps of blowing, relaxing and reblowing. The mold 80 can quickly cool the container during this process, especially with high heat transfer material absorbing heat from the container at a high rate.

As discussed, in some embodiments, the mold 80 can be used to produce crystalline or semi-crystalline neck finishes. For example, the blow mold neck portion 706 and the blow mold body portion 708 can selectively control the temperature of the preform/container to achieve a desired amount of crystallization. Thus, the neck portion of the preform/container can be heated and gradually reduced in temperature to produce a desired amount of crystalline and/or semi-crystalline material. To enhance thermal isolation, inserts 750 may be used to reduce heat transfer between portions of the mold 80. The illustrated inserts 750 are positioned between the blow mold neck portion 706 and the blow mold body portion 708 and can be formed of an insulator. In other arrangements, however, no degree of crystallization for the preforms or other molded items is desired.

In some embodiments for preforms in which the neck finish is formed primarily of PET, the preform can be heated to a temperature of approximately 80° C. to 120° C., with higher temperatures being preferred for the heat-set embodiments, and given a brief period of time to equilibrate. After equilibration, the preform can be stretched to a length approximating the length of the final container. Following the stretching, pressurized air, such as chilled food grade air, may be forced into the preform to expand the walls of the preform so that it generally fits the mold in which it rests. Accordingly, a bottle or other container with a shape corresponding to the mold is created. Working fluid (e.g., cooling water, cryogenic fluids, non-cryogenic fluids, refrigerants, other fluids, etc.) can be circulated through the channels 712, 714 to help cool the container contacting the interior surface 718. The temperature of the chilled air for stretching the preform and the temperature of the working fluid cooling the interior surface 718 can be selected based on the desired container finish, production time, and the like.

FIG. 6A illustrates another embodiment of the mold for stretch blow molding preforms. The depicted blow mold body portion 708a comprises an inner portion 740 and an outer portion 742. The inner portion 740 and the outer portion 742 can comprise materials with different thermal conductivities. The inner portion 740 defines blow molding interior surface 718a and, in some arrangements, comprises a high heat transfer material. A chilled fluid, such as a refrigerant, can be passed through the channels 710a to rapidly cool the blow molded container. The outer portion 742 can form a thermal barrier to reduce heat transfer to the surrounding environment. The outer portion 742 surrounds the inner portion 740 to thermally isolate the inner portion 740. The outer portion 742 can comprise steel or other thermally insulating material in comparison to the material forming the inner portion 740.

The mold neck portion 706a can comprise a neck portion 746 and an upper neck portion 748. The neck portion 746 may comprise one or more high heat transfer materials, as desired or required by a particular application or use. In addition, the upper neck portion 748 can comprise an insulating material to thermally isolate the internal portions of the mold 80a similar to the body portion 708a.

The temperature of the interior surfaces of the blow molds 80, 80a can be selected based on the preform design. For example, the temperatures of the interior mold surfaces can be different for blow molding preforms comprising an outer layer of foam material and for blow molding preforms comprising an outer layer of PET. Although the blow mold 80 is discussed primarily with respect to stretch blow molding a preform, the mold 80 can be an extrusion blow mold. Thus, it is contemplated that the mold 80 can be used for an extrusion blow molding process. Additionally, the embodiments, features, systems, devices, materials, methods and techniques described herein may, in some embodiments, be similar to any one or more of the embodiments, features, systems, devices, materials, methods and techniques described in U.S. patent application Ser. No. 11/108,607 (U.S. Publication No. 2006-0073298) entitled MONO AND MULTI-LAYER ARTICLES AND EXTRUSION METHODS OF MAKING THE SAME, filed on Apr. 18, 2005 which is incorporated herein by reference in its entirety.

1. Method and Apparatus of Making Crystalline or Semi-Crystalline Material

Molds (including compression and injection molds) can be used to produce preforms having a crystalline or semi-crystalline material. While a non-crystalline preform may be preferred for blow-molding, a bottle having greater crystalline or semi-crystalline properties or characteristics may be preferred for its dimensional stability during a hot-fill process. Accordingly, in some embodiments, a preform can include a generally non-crystalline body portion and a generally crystalline or semi-crystalline neck portion. To create generally crystalline or semi-crystalline and generally non-crystalline portions in the same preform, one needs to achieve different levels of heating and/or cooling in the mold in the regions from which crystalline or semi-crystalline portions will be formed as compared to those in which generally non-crystalline portions will be formed. The different levels of heating and/or cooling are preferably maintained by thermal isolation of the regions having different temperatures. In some embodiments, this thermal isolation between the thread split, core and/or cavity interface can be accomplished utilizing a combination of low and high thermal conduct materials as inserts or separate components at the mating surfaces of these portions.

The cooling of the mold in regions which form preform surfaces for which it is preferred that the material be generally amorphous or semi-crystalline, can be accomplished by chilled fluid circulating through the mold cavity and core. In some embodiments, a mold set-up similar to conventional injection molding applications is used, except that there is an independent fluid circuit or electric heating system for the portions of the mold from which crystalline or semi-crystalline portions of the preform will be formed. Any of the molding systems disclosed herein can be configured to produce preforms having crystalline material. A cavity section can include the body mold comprising several channels through which a fluid, preferably chilled water or a refrigerant, is circulated. The neck finish mold can include one or more channels in which a fluid circulates. The fluid and circulation of channels and channels are preferably separate and independent.

A desired level of thermal isolation of the body mold, neck finish mold and/or core section can be achieved by use of inserts or having low thermal conductivity. Examples of preferred low thermal conductivity materials include heat-treated tool steel (e.g. P-20, H-13, Stainless etc.), polymeric inserts of filled polyamides, nomex, air gaps and minimum contact shut-off surfaces.

In such independent fluid circuits through channels, cooling fluid can be warmer than that used in the portions of the mold used to form non-crystalline portions of the preform. Fluids can include, but are not limited to, water, silicones, cryogenic or non-cryogenic liquids or fluids, oils and/or other fluids. In another embodiment, the portions of the mold which forms the crystalline or semi-crystalline portions of the preform, (corresponding to a neck finish mold) contain a heating apparatus placed in the neck, neck finish, and/or neck cylinder portions of the mold so as to maintain the higher temperature (slower cooling) to promote crystallinity of the material during cooling. Such a heating apparatus can include, but is not limited to, heating coils, heating probes, and electric heaters. Additional features, systems, devices, materials, methods and techniques are described in U.S. patent application Ser. No. 09/844,820 (U.S. Publication No. 2003-0031814) which is incorporated by reference in its entirety and made a part of this specification. Additionally, the channels can be used to heat the molds and cause expansion of foam material.

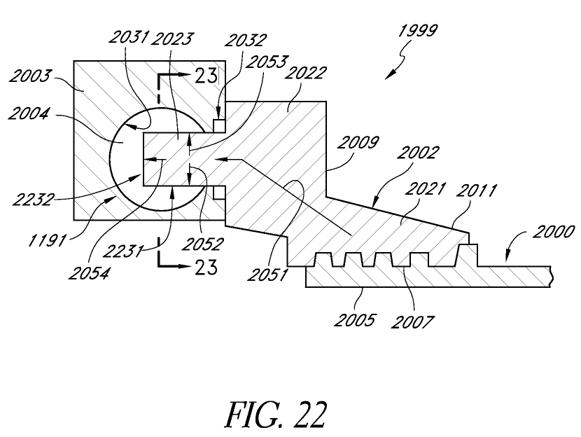

FIG. 22 illustrates a cross-sectional view of a portion of a mold configured to mold a preform 2000. The mold 1999 comprises a neck finish mold 2002 and a component 2003 of a mold cavity section. Alternatively, the component 2003 may be intricately formed within the same structure as the neck finish mold or be part of another member. The preform 2000 has a neck finish 2005 that is molded, at least in part, by the neck finish mold 2002. In the illustrated embodiments, the neck finish mold 2002 and component 2003 are in thermal communication with each other. A cooling system 1191 is disposed within the component 2003. To cool the preform 2000, a chilled working fluid can flow through the cooling system 1191 and across at least a portion of the neck finish mold 2002. The cooling system 1191 can have at least one channel 2004, which is defined by an interior wall 2031. Fluid flowing through the channel 2004 can flow around a portion of the neck finish mold 2002 positioned within the channel 2004, and can absorb heat from the neck finish mold 2002. As used herein, the term “chilled working fluid” is a broad term and is used in its ordinary sense and refers, without limitation, to non-cryogenic refrigerants (e.g., Freon) and cryogenic refrigerants. As used herein, the term “cryogenic refrigerant” is a broad term and is used in its ordinary sense and refers, without limitation, to cryogenic fluids. As used herein, the term “cryogenic fluid” means a fluid with a maximum boiling point of about −50° C. at about 5 bar pressure when the fluid is in a liquid state. In some non-limiting embodiments, cryogenic fluids can comprise CO₂, N₂, Helium, combinations thereof, and the like. In some embodiments, the cryogenic refrigerant is a high temperature range cryogenic fluid having a boiling point higher than about −100° C. at about 1.013 bars. In some embodiments, the cryogenic refrigerant is a mid temperature range cryogenic fluid having a boiling point between about −100° C. and −200° C. In some embodiments, the cryogenic refrigerant is a low temperature range cryogenic fluid having a boiling point less than about −200° C. at about 1.013 bars. The terms “chilled working fluid,” “chilled fluid,” “chilling fluid,” and “cooling fluid” may be used interchangeably herein.

Heat from the warm molded preform 2000 can flow through the neck finish mold 2002 to the working fluid flowing through the cooling system 1191. As such, the neck finish mold 2002 and the component 2003 cooperate to transfer part of the heat away from the preform 2000 for a reduced cycle time. The mold 1999 can be included in a machine used for and/or in processes for injection molding, compression molding, extrusion blow molding or any other type of plastics molding.

In some embodiments, including the illustrated embodiment of FIG. 22, the neck finish mold 2002 is in the form of a thread split that has a molding surface 2007 configured to mold threads on the neck portion 2005 of the preform 2000. The molding surface 2007 at least partially defines a mold cavity or mold space in which a moldable material is received and molded. The terms “mold cavity” and “mold space” may be used interchangeably herein. The neck finish mold 2002 can, however, have other configurations depending on the desired article to be formed. For example, the illustrated neck finish mold 2002 also comprises a body 2009 and a heat transfer member 2023 in thermal communication with each other. Furthermore, although a screw top type finish mold is shown, other types of finishes may be molded, such as press fit, snap-on and the like.

At least a portion of the heat transfer member 2023 can be positioned, at least partially, within the channel 2004. In other embodiments, an extension (not shown) of the heat transfer member in thermal communication with the heat transfer member 2023 can be positioned within the channel 2004. Working fluid can flow through the channel 2004 and absorb heat from the heat transfer member 2023. Alternatively, the heat transfer member 2023 can be used to provide heat to the preform 2000 or other product being molded, by absorbing heat from the channel 2004 and delivering it to the molding surface 2007. As used herein, the term “heat transfer member” is a broad term and is used in its ordinary meaning and includes, without limitation, a protrusion, an extension, an elongated member, and/or a heat transfer element. The heat transfer member can have a hollow or solid construction. Heat can be transferred from the heat transfer member to a fluid surrounding all or part of the heat transfer member. Heat transfer members can have a one-piece or multi-piece construction. The illustrated heat transfer member 2023 of FIG. 22 has a one-piece construction and is monolithically formed with the body 2009. The heat transfer member 2023 protrudes from the body 2009 and extends, at least partially, through the channel 2004. In other embodiments, the heat transfer member 2023 may extend across the entire channel 2004 or a substantial distance across the channel 2004.

The body 2009 of the neck finish mold 2002 comprises a frontal portion 2021 that defines a surface 2011 configured to engage a lower component of the cavity section of the mold 1999, and the molding surface 2007. In the illustrated embodiment, the frontal portion 2021 includes a slight taper towards the body portion of the preform 2000. A central section 2022 of the body 2009 is connected to the frontal portion 2021 and the heat transfer member 2023. The frontal portion 2021, the central section 2022, and/or the heat transfer member 2023 may be separate items or a unitary member. Regardless, heat can be transferred along a flow path 2051 through the frontal portion 2021, the central portion 2022, and the heat transfer member 2023, and then ultimately to a fluid passing through the channel 2004. The fluid can flow adjacent to any portion of the heat transfer member 2023 and/or across any other portion of the neck finish mold 2002.

The neck finish mold 2002 may comprise a high heat transfer material. In some embodiments, including the illustrated embodiment of FIG. 22, the neck finish mold 2002 can comprise mostly a high heat transfer material, although other materials can be employed to reduce wear, provide thermal insulation, and the like. For example, the neck finish mold 2002 can comprise more than about 50%, 55%, 60%, 65%, 70%, 75%, 80%, 85%, 90%, 95%, 98%, 99%, or ranges encompassing such percentages of high heat transfer material by weight and/or volume. In another embodiment, the entire neck finish mold 2002 is comprised of one or more high heat transfer materials. In yet other embodiments, the neck finish mold 2002 may comprise less than about 50%, 45%, 40%, 35%, 30%, 25%, 20%, 15%, 10%, 5%, 2%, 1%, or ranges encompassing such percentages. In yet other arrangements, the neck finish mold 2002 may not comprise any high heat transfer materials. Thus, in some embodiments, heat transfer from the molding surface to the channel 2004 may involve both the use of a high heat transfer material in the mold and the use of a cryogenic refrigerant and/or other fluid.

In some non-limiting embodiments the neck finish mold 2002 comprises one or more high heat transfer materials that define a heat flow path 2051. As illustrated in FIG. 22, the heat flow path 2051 may be oriented along a middle portion of the mold body 2009. However, in other embodiments, a heat flow path 2051 may be different than shown in FIG. 22. For example, the flow path 2051 may be oriented along one or more outer portions of the mold body 2009. In other embodiments, a mold body 2009 may comprise two or more different heat flow paths 2051. Further, if the heat transfer member 2023 is used to deliver heat to the molding surface 2007, the general direction of the flow path may be opposite or substantially opposite of that depicted in FIG. 22.

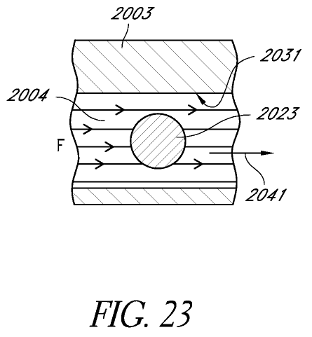

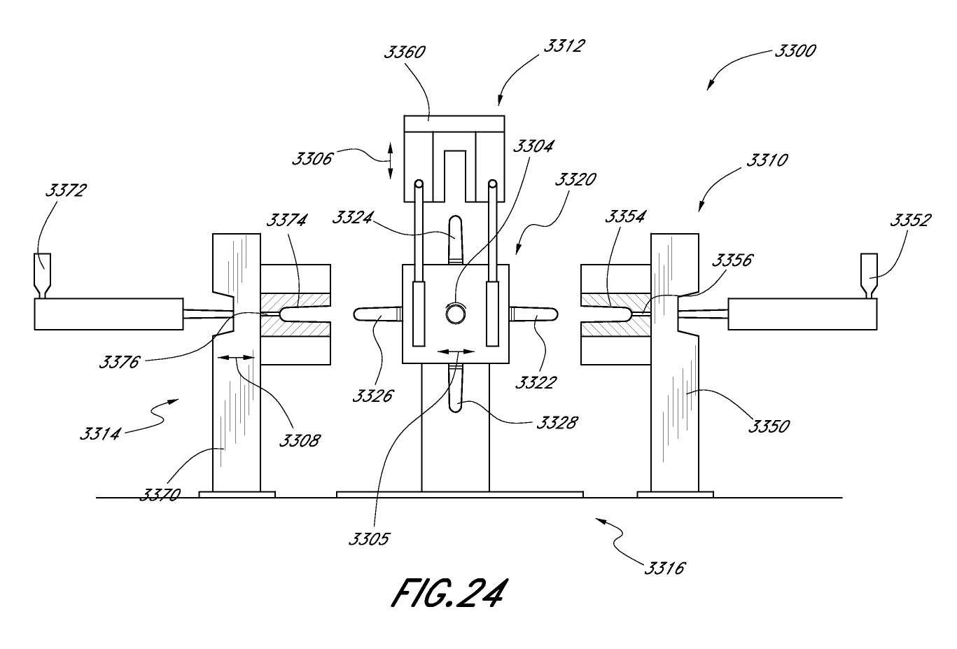

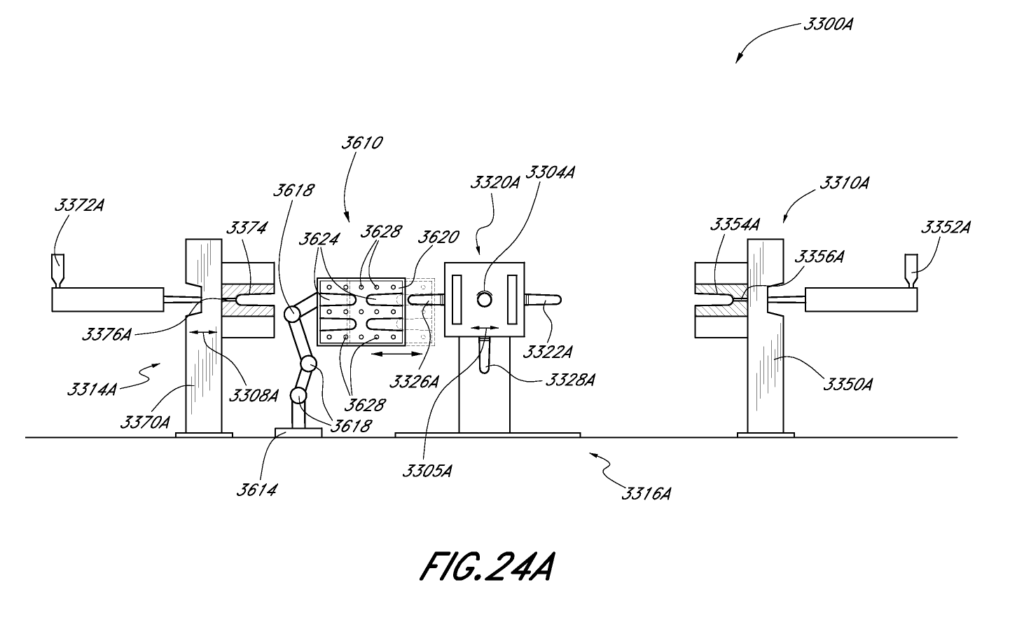

FIG. 23 illustrates the heat transfer member 2023 and the component 2003 taken along the line 23-23 of FIG. 22. During the molding cycle, working fluid, such as, for example chilled working fluid (e.g., non-cryogenic refrigerant, cryogenic refrigerant, water, etc.) can flow through the channel 2004 and around the heat transfer member 2023. In some non-limiting embodiments, the working fluid comprises water. The water is heated as it absorbs heat from the heat transfer member 2023. The working fluid can be chilled, hot, or at any other temperature to heat or cool the neck finish mold 2002 as desired. Additional details regarding the neck finish mold 2002 are provided in U.S. application Ser. No. 11/512,002, filed Aug. 29, 2006 and published as U.S. Patent Application No. 2007-0108668, the entirety of which is hereby incorporated by referenced herein.

In some preferred embodiments, pulse cooling or similar technology can be incorporated into one or more mold sections. If a cooling fluid is conveyed through the channel 2004 when the mold space does not include a preform or other object or when the mold space or cavity is otherwise exposed to ambient air, moisture from the surrounding air can condense on a molding surface. The condensation may interfere with the molding operation by reducing preform production, decreasing molding quality, increasing cycle times and the like. Therefore, it may be desirable in certain embodiments to eliminate cooling of one or more mold sections (e.g., core, cavity, etc.) when molding surfaces are exposed to moist air or other conditions where condensation can form on a molding surface.

### E. Improved Molding System

FIG. 24 illustrates one embodiment of an injection molding system 3300 comprising a rotating cube 3320. In the depicted embodiment, the cube 3320 is configured to rotate counter-clockwise about an axis, in a direction generally represented by arrow 3304. The cube 3320 can comprise one or more mandrels or cores 3322, 3324, 3326, 3328 extending from four of its exterior surfaces. However, in other arrangements, the cube 3320 can comprise cores along fewer of its exterior surfaces (e.g., two, three, etc.). As discussed in greater detail herein, the cube 3320 can be configured to rotate in 90 degree increments to permit the mandrels 3322, 3324, 3326, 3328 to mate with corresponding cavity sections 3354, 3374 in preparation for receiving one or more injection layers, overmolding or overinjection layers coatings and/or the like. In addition, the cube 3320 can rotate or otherwise move to advance preforms or other molded materials situated thereon to other stations. In some embodiments, the cube 3320 is rotated or otherwise advanced so that the preforms can be cooled, additionally treated or conditioned (e.g., surface treatment such as flame treatment, corona treatment, ionized air treatment, plasma air treatment, plasma arc treatment, etc.), ejected from the cube 3320 and/or the like.

With continued reference to the embodiment depicted in FIG. 24, the injection molding system 3300 includes four separate stages or steps. In other embodiments, the molding system can include fewer or more stages or steps, as desired or required by a particular application or use. In some configurations, no molding, treatment and/or other processes occur at one or more of the steps or stages. For example, one or more of the stages or steps can comprise only cooling of the preform or other molded item.

During a first stage or step 3310 in the illustrated system, injection molding of a first layer of a preform or other moldable item occurs. The molding system 3300 can comprise one or more cavity sections 3354, which are preferably configured to mate with adjacent mandrels or cores 3322 of the cube 3320. The mandrels 3322 and the adjacent cavity sections 3354 of the molding system 3300 can mate by moving the cube 3320 relative to the cavity platen 3350. In some embodiments, the cube 3320 is moved toward the cavity platen 3350. Alternatively, the cavity platen 3350 can be moved toward the cube 3320. In yet other arrangements, both the cube 3320 and the cavity platen 3350 are moved toward each other. Regardless of the exact manner in which the cube 3320 and cavity platen 3350 mate, once the mandrels 3322 of the cube 3320 mate with corresponding cavity sections 3354 of the cavity platen 3350, one or more mold cavities are formed. Consequently, molten material (e.g., PET) from the injection apparatus 3352 can be delivered into each mold cavity (e.g., through a gate 3356 or other injection area or port of the mold cavity sections 3354).

PET and/or other thermoplastic materials injected into the mold cavities can be cooled, at least in part, using cooling channels situated within the cavity platen 3350 and/or the cube 3320. Such cooling channels can be configured to circulate water and/or other cooling fluids that help transfer heat away from the preforms and adjacent mold surfaces. In some embodiments, the cavity sections 3354 and/or the cores 3322 comprise one or more high heat transfer materials (e.g., Ampcoloy, alloys of copper and/or beryllium, etc.). This can advantageously enhance the ability of the system to quickly and efficiently cool the preforms being formed within the mold cavities.

In some embodiments, cooling fluids are circulated through cooling channels of the cavity sections 3354 at the same time or after the PET or other thermoplastic material is injected into the mold cavities. Such a cooling scheme can advantageously decrease the time that the cavity platen 3350 and the cube 3320 remain in a mated position during the initial injection stage or step 3310. As discussed in greater detail herein, the cores 3322 can also comprise internal cooling channels, high heat transfer materials and/or other cooling features that permit a user to quickly cool interior surfaces of the preforms or other items being molded. In some embodiments, the cooling channels of the cores 3322 are connected to a cooling fluid source using a rotary union or other specially-designed fitting that permits cooling fluids to be delivered to the channels even while the cube 3320 is being rotated or otherwise indexed. Further, as discussed in greater detail herein, fluid flow through the cooling channels of the different sets of cores 3322, 3324, 3326, 3328 of the cube 3320 can be individually controlled (e.g., independent of other sets of cores) in order to achieve a desired cooling effect at each stage or step of the process.

After an appropriate amount of cooling of the preform occurs, as is described in greater detail herein, the cube 3320 can be indexed to a subsequent treatment step or station (e.g., counterclockwise by 90 degrees in the illustrated embodiment). In other embodiments, an injection molding system can be configured to be indexed by a different rotation angle and/or by an entirely different manner. The layer of PET and/or other thermoplastic material injected during the first station 3310 can be configured to remain on the corresponding mandrels 3322, and thus, move with the mandrels 3322 through subsequent stages or stations. This can be accomplished by controlling the relative cooling rate of the cores 3322 and the adjacent cavity section 3352. For example, in some arrangements, the cores 3322 and the cavities 3352 are cooled in a manner that will cause the preform to shrink onto the cores.

With continued reference to FIG. 24, at the second stage or station 3312, the preform substrate layers formed during the first stage 3310 can undergo cooling, surface treatment and/or any other type of additional preparation or processing. In some embodiments, the preforms undergo temperature conditioning through exterior and/or interior cooling and/or heating. For example, water or other cooling fluids can be circulated through one or more interior cooling channels of the cores 3322 to cool the preform. In other embodiments, additional heat transfer can occur across the exterior surface of the preforms. As discussed in greater detail herein, the regulation and control of the preforms' temperature can be important to one or more other steps associated with a molding procedure (e.g., overmolding, ejection, surface preparation, etc.). For example, the cooling effect created by cooling fluids circulated through the cores 3322 can be advantageously customized to optimize or otherwise improve adhesion of an over-injection layer and/or other coating (e.g., RPET) along the exterior surface of the preforms during a subsequent stage or step.

According to some embodiments, the first layer of each preform can undergo one or more types of surface treatment during the second stage 3312. In some arrangements, surface treatment or other processing or treatment procedures can occur at other stages of a molding system 3300, either in lieu of or in addition to the second stage 3312. As disclosed in greater detail in U.S. patent application Ser. No. 11/546,654 (U.S. Publication No. 2007-0087131), titled METHODS OF FORMING MULTILAYER ARTICLES BY SURFACE TREATMENT APPLICATIONS and filed Oct. 12, 2006, surface treatment of the preform can comprise flame treatment, corona treatment, ionized air treatment, plasma air treatment, plasma arc treatment, surface abrasion and/or the like. U.S. patent application Ser. No. 11/546,654 is incorporated by reference herein in its entirety. As discussed, such surface preparation can improve the adhesion of one or more exterior layers (e.g., PET, RPET, barrier layers, etc.) which may be subsequently applied to the outside of the first layer of the preforms.

In order to carry out the necessary surface treatment or other processing or conditioning to the preforms, the molding system 3300 can be configured to move a treatment platen 3360 relative to the cube 3320. With reference to FIG. 24, the platen 3360, which in the illustrated embodiment is positioned above the cube 3320, can be configured to lower toward the cube 3320. In other embodiments, the cube 3320 can be configured to move toward the treatment platen 3360, either in lieu of or in addition to the treatment platen 3360 moving toward the cube 3320.

After the desired temperature conditioning, surface treatment and/or other processing steps have been completed, the cube 3320 can be indexed (e.g., in a counterclockwise direction by another 90 degrees in the depicted arrangement). As illustrated in FIG. 24, such rotation or other indexing of the cube 3320 can permit the core 3322 and the preforms situated thereon to move to a third stage or station 3314 of the molding system 3300. In some embodiments, the third stage 3314 comprises the application of an overinjection material to the outside of the preforms.

With continued reference to embodiment illustrated in FIG. 24, the third stage 3314 can comprise an overinjection cavity platen 3370 which includes one or more overinjection cavity sections 3374. As with the application of the first preform layer, the mandrels 3322 of the cube 3320 can be configured to mate with corresponding cavity sections 3374 to form a mold cavity or void therebetween. In order for the cores 3322 to properly mate with the corresponding cavity sections 3374, the overinjection cavity platen 3370 can be moved towards the cube 3320. Alternatively, the cube 3320 can be moved toward the overinjection cavity platen 3370, either in lieu of or in addition to moving the overinjection cavity platen 3370 towards the cube 3320.

A volume of an overmolding material and/or other coating, such as, for example, PET, RPET, a barrier material and/or the like, can be introduced into the mold cavity from the injector 3372 via a gate 3356 or other port located in each of the cavity sections 3374. Thus, an overmolding material can flow around each of the preforms situated on the mandrels 3322. Following overinjection, the overmolded layer can take the approximate size and shape of the void space between the adjacent surfaces of the cores 3322 and the overinjection cavity sections 3374.

Finally, with both the initial and the overinjection layers of the preforms on its mandrels 3322, the cube 3320 can be indexed (e.g., by another 90-degree rotation) to a fourth stage or station 3316. At the fourth stage 3316, the preforms can be further cooled (or otherwise temperature conditioned) before being ejected from the mandrels 3322 using one or more methods. In other embodiments, additional coatings and/or thermoplastic layers can be added to the preforms at the fourth stage 3316. The preforms can be removed from the corresponding cores 3322 using an air eject or mechanical stripping system. In other embodiments, the preforms or other molded items are removed using a robot or other mechanical device (see FIG. 24A). As discussed in greater detail herein, such a robot or other mechanical device can be configured to further cool the preforms before depositing them on a conveyor, in a container and/or any other location. It will be appreciated that any other method can be used to remove the preforms.

In the embodiment illustrated in FIG. 24 and the accompanying discussion herein, a single set of mandrels 3322 was followed through the various stations 3310, 3312, 3314, 3316 of the molding system 3300. However, as shown, the cube 3320 includes mandrels on four of its sides. Thus, the various steps discussed herein (e.g., injection, overinjection, surface treatment, cooling, ejection, etc.) can occur simultaneously. For example, while the first layers of molten material are being injected onto the cores 3322 at the first station 3310, the preforms on the cores 3324 at the second station 3312 are being cooled and/or surface treated, the cores 3326 at the third station 3314 are receiving an overinjection layer and the preforms are being ejected or otherwise removed from the cores 3328 at the fourth station 3316. After a molding cycle is completed, the process repeats. For instance, after the preforms are ejected at the fourth station 3316, the cube 3320 is indexed to the first station 3310, where each of the cores 3328 receives a first layer of PET, other substrate or other molten material in order to produce a new set of preforms.

Such a sequential scheme can improve the efficiency of the preform molding process. Consequently, cycle times associated with the production of injection molded items, especially multi-layer preforms, can be advantageously reduced.

Another embodiment of an injection molding system 3300A comprising a core cube 3304A that can be rotated or otherwise indexed between various molding, treatment and/or other types of stages or steps is illustrated in FIG. 24A. In the depicted arrangement, the cube 3320A of the molding system 3300A includes cores or mandrels 3322A, 3326A on only two of its surfaces. The surfaces of the cube 3320A that comprise cores 3322A, 3326A can be located opposite one another, as shown herein. However, one or more other surfaces of the cube 3320A can include cores 3322A, 3326A, either in lieu of or in addition to the two surfaces in the illustrated embodiment.

With continued reference to FIG. 24A, the molding system 3300A can include a first step or station 3310A where initial preform layers are formed. As discussed herein with reference to other arrangements, the cube 3320A can be moved relative to the cavity platen 3350A (e.g., in a direction generally represented by arrow 3305A) so that the cores 3322A mate with corresponding mold cavities 3354A. Alternatively, the cavity platen 3350A can be moved relative to the cube 3320A. Regardless of the exact manner in which the cube 3320A and the cavity platen 3350A are brought into mating contact, a plurality of mold cavities can be formed between the cores 3322A and the cavity sections 3354A.

Accordingly, molten material (e.g., PET) from the injection apparatus 3352A can be delivered into each mold cavity (e.g., through a gate 3356A or other injection area or port of the mold cavity section 3354A). As discussed, the molding system 3300A can be advantageously configured to permit customized cooling of the cores 3322A and the cavity sections 3354A. For example, one or more cooling channels, high heat transfer materials, pressure reducing valves configured to receive refrigerants and/or other components or features can be included within or near the cores 3322A and/or cavity sections 3354A.

In some embodiments, cooling fluids are directed through corresponding channels of the cavity sections 3354A when molten thermoplastics are initially injected into the mold cavities. This can help ensure that the thermoplastic is adequately cooled within a particular time in order to be able to index the cube 3320A to the next stage or step. In addition, cooling fluids can be delivered through channels of the cores 3322A in order to achieve a desired cooling effect along the interior portion of the preforms. For example, the cores 3322A and the cavities 3354A can be cooled in a way that causes the injected thermoplastic material to shrink onto the cores 3322A. Thus, the preforms can remain on the cores 3322A as the cube 3320A is rotated or otherwise indexed to subsequent overmolding and/or treatment steps. In other embodiments, the cores 3322A and/or the cavities 3354A are cooled in a manner that ensures that the temperature of the preforms formed therebetween is within a desired range when it reaches a subsequent overinjection step. By maintaining the preform within such a desired temperature range, adhesion between the initial substrate (e.g., PET) layer and any subsequent overmolding layers can be improved.

Accordingly, the cores 3322A, 3326A and the cavities 3354A, 3374A of the system 3300A can be configured to permit a user to easily adjust and otherwise customize the cooling effect along an interior and an exterior portion of the preform layers being molded. As discussed in greater detail herein, the cooling channels within the cube 3320A can be in fluid communication with one or more fluids using a rotary union and/or other types of specially-designed fittings that permit the delivery of fluids to such cooling channels even while the cube 3320A is being rotated or otherwise indexed.

With continued reference to FIG. 24A, the molding system 3300A can include a second step or stage 3314A where overmolding layers and/or other coatings can be applied to the outside of the preforms. Thus, after an initial layer of PET or other substrate has been formed along the outside of the cores 3322A, the cube 3320A can be rotated or otherwise indexed to the second stage 3314A. In the illustrated embodiment, the cube 3320A is rotated by 180 degrees in a counterclockwise direction (e.g., generally represented by arrow 3304A). However, in other arrangements, the manner and degree to which a cube is indexed between various production and/or treatment stages can vary, as desired or required by a particular application.

As illustrated in FIG. 24A, once the cores 3326A have been moved to the second station 3314A, the overinjection cavity platen 3370A and/or the cube 3320A can be moved so that the cores 3326A mate with corresponding overinjection cavities 3374A. Accordingly, a volume of an overmolding material and/or other coating, such as, for example, PET, RPET, other recycled materials, a barrier material and/or the like, can be introduced into the mold cavity from the injector 3372A via a gate 3356A or other port located in each of the cavity sections 3374A. Thus, an overmolding material can flow around each of the preforms situated on the mandrels 3326A. Following overinjection, the overmolded layer can take the approximate size and shape of the void space between the adjacent surfaces of the cores 3326A and the overinjection cavity sections 3374A.

The embodiment of the molding system illustrated in FIG. 24A does not include dedicated intermediate treatment steps or stages (e.g., for surface treatment, dedicated cooling, etc.). As such, it represents one embodiment of an injection-overinjection system that is configured to further decrease the production time of preforms. The reduction in cycle time can be attributed, at least in part, to the elimination of separate stages or steps at which the cube 3320A would otherwise need to stop for the execution of specific production, treatment, conditioning and/or other procedures. However, it will be appreciated that in other embodiments, a molding system can include a fewer or greater number of steps or stations, as desired or required.

As illustrated in FIG. 24A, a molding system or apparatus 3320A can include a robot 3610 or other mechanical device to facilitate removal of one or more preforms from the cores 3326A. It will be appreciated that such a robot 3610 or other mechanical device can be used with any of the embodiments of molding systems or apparatuses disclosed herein. As shown, the robot 3610 can include a base member 3614 and one or more joints 3618 that permit a grasping portion 3620 of the device to be moved in one, two or three directions. In addition, one or more of the joints 3618 can be configured to swivel or otherwise articulate so that the grasping portion 3620 can be selectively rotated as desired or required. Thus, the robot 3610 can be configured as a three-axis or four-axis system.

With continued reference to FIG. 24A, the robot 3610 is generally positioned along the side of the indexing cube 3320A and the overinjection cavity platen 3370A. Thus, the grasping portion 3620 of the robot 3610 can be moved generally laterally to engage and remove the preforms situated on the cores 3326A. Alternatively, the robot 3610 can be situated in one or more other locations (e.g., above or below the cube 3320A) as long as it is adequately configured to engage and remove the preforms from the cores 3326A.

The grasping portion 3620 of the robot 3610 can include openings 3624 or other features that are adapted to receive the preforms or other molded items situated on the corresponding cores 3326A of the cube 3320A. In some embodiments, the openings 3624 are shaped, sized and otherwise configured to receive the preforms substantially without causing damage to them. Further, the grasping portion 3620 can comprise mechanical ejectors or other stripping devices or features that facilitate removal of the preforms from the cores 3326A.

In use, once an overinjection layer has been applied to the preforms (e.g., at the second stage 3314A), the cube 3320A and the overinjection cavity platen 3370A can disengage (e.g., move laterally away from each other in a direction generally represented by arrow 3305A). Once sufficient space has been provided, the grasping portion 3620 of the robot 3610 can be moved so that its openings 3624 align with and engage the corresponding cores 3326A of the cube 3320A. As discussed, the grasping portion 3620 of the robot 3610 can be automatically positioned into a desired orientation by articulating one or more joints 3618. In one embodiment, once the preforms are securely positioned within the openings 3624 of the grasping portion 3620, the cube 3320A moves away from the grasping portion 3620. Consequently, the preforms can advantageously remain within the openings 3624 of the grasping portion 3620. In some arrangements, a mechanical stripper, a fluid injection system and/or the like can be used to help disengage the preforms from the cores 3326A.

In some embodiments, the grasping portion 3620 can be moved away from the cube 3320A, allowing the cube 3320A to be indexed. This can advantageously permit the injection-overinjection process to continue, thereby reducing overall cycle time. As illustrated in FIG. 24A, the grasping portion 3620 can include cooling channels 3628, high heat transfer materials and/or other features or components that permit additional cooling of the preforms after their removal from the cores 3326A. Once a desired time has elapsed (e.g., to additionally cool or otherwise condition the preforms), the preforms can be ejected from the openings 3624 of the grasping portion 3620. In some arrangements, the preforms are deposited onto a moving conveyor belt, which transfers the preforms to another location for additional processing or treatment (e.g., coating, blow molding, temperature treatment, packaging, transport, etc.).

In some embodiments, the preforms are removed from the robot 3610 by simply tilting, rotating or otherwise moving the grasping portion 3620. However, one or more other devices or methods of removing the preforms can be used, either in lieu of or in addition to titling the grasping portion 3620. Further, the grasping portion 3620 can be sized, shaped and otherwise configured to capture and retain preforms from two or more cycles. For example, as illustrated in FIG. 24A, the grasping portion 3620 can comprise openings 3624 along two or more of its surfaces. Thus, by rotating the grasping portion 3620 (e.g., in a manner generally represented by arrow 3622), the grasping portion 3620 can be configured to advantageously retain preforms removed from the cores 3326A at the completion of various production cycles. This can help reduce cycle times, as the preforms can be cooled within the grasping portion 3620 of the robot 3610.

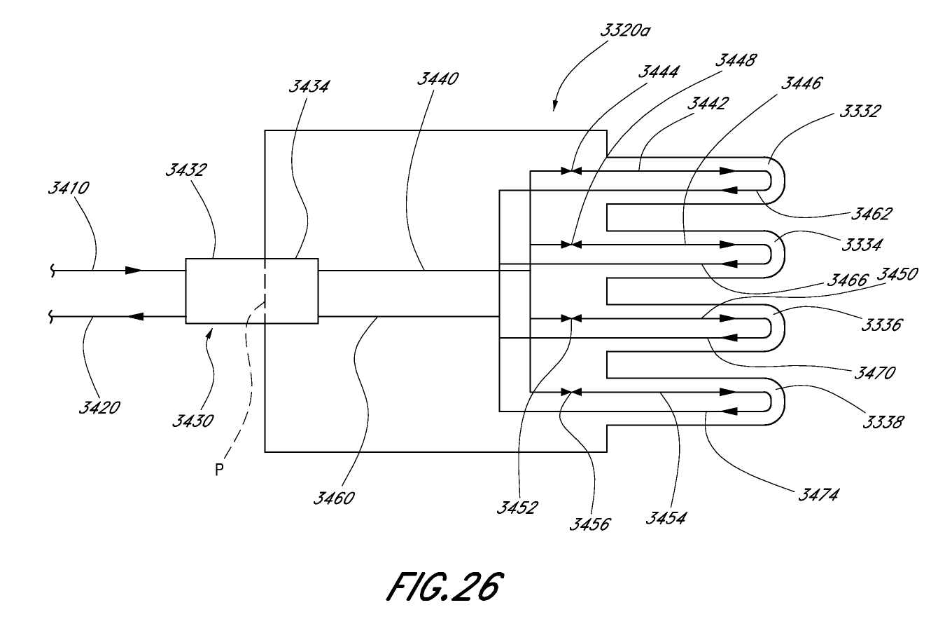

FIG. 25 schematically illustrates one embodiment of a cube 3320 for use in a molding system 3300 as disclosed herein. As shown, each mandrel or core 3322, 3324, 3326, 3328 (or each set of mandrels or cores) comprises one or more internal channels or tubes 3330, 3334, 3340, 3344, which are configured to circulate cooling water or other fluid through the mandrel or core bodies. For simplicity, only a single mandrel 3322, 3324, 3326, 3328 is illustrated on each face of the cube 3320. However, it will be appreciated that two or more mandrels can be included on each side of the cube 3320.

In the depicted embodiment, each of the cooling channels 3330, 3334, 3340, 3344 comprises both an inlet 3332a, 3336a, 3342a, 3346a and a corresponding outlet 3332b, 3336b, 3342b, 3346b. Thus, cooling water or other fluids can be delivered to the mandrels through inlets 3332a, 3336a, 3342a, 3346a and removed through outlets 3332b, 3336b, 3342b, 3346b. In the illustrated embodiment, the cooling channels 3330, 3334, 3340, 3344 are configured to deliver cooling water or other fluids to the distal end of each mandrel. In addition, as shown, each mandrel comprises only a single cooling channel. In alternative embodiments, however, the mandrels can comprise more or fewer cooling channels. In addition, the exact orientation of the cooling channels within the mandrels can be different than illustrated and discussed herein.

As discussed, in some embodiments, it is desirable to vary the extent to which a mandrel 3322, 3324, 3326, 3328, and thus a preform situated on such a mandrel, is cooled. For example, it may be advantageous for the temperature of the mandrel which has just received the first layer of molten material (e.g., PET) at the first station 3310 to be relatively cold or warm. As discussed, the cooling of the mandrels can be controlled so that the temperature of the first layer of the preform formed thereon is within a target range. This can help ensure that the first layer adequately receives and adheres to a subsequent overmolding layer (e.g., RPET). In other embodiments, enhanced cooling of the first molten layer can reduce the time needed to de-mold the preform from the corresponding cavity section 3354. This can reduce the overall molding cycle time, as the cooling of the initial layer of molten material does not become the time-limiting step. To further increase the cooling effect of the first layer of molten material, the molding system 3300 can include one or more additional features and/or characteristics. For example, one or more portions of the mandrels 3322, 3324, 3326, 3328 and/or cavity sections 3354, 3374 can include a high heat transfer material (e.g., Ampcoloy, alloys of copper and/or beryllium, etc.). In addition, the cavity sections 3354, 3374 can comprise their own cooling channels or any other device or method for enhancing the heat transfer from the preform.

Further, it may be desirable to reduce or eliminate the cooling effect on the mandrels, and thus the preforms situated thereon, after the first layer of PET or other polymeric material has been de-molded from the first station 3310. For example, the surface treatment or other processing occurring at the second station 3312 and/or the subsequent application of an overmolding layer (e.g., PET, RPET, other recycled materials, barrier materials, etc.) at the third station 3314 may benefit from a higher preform temperature. For example, adhesion between an outer overinjection layer and an inner layer can be realized when the exterior surface of the inner layer is within a target temperature range. Thus, in some embodiments, the cooling of the mandrels positioned at the second station 3312 can be reduced or completely eliminated. It will be appreciated, however, that in other arrangements, it may desirable to maintain a relatively high cooling effect in the mandrels at the second station 3312.

Moreover, following the injection of the overmolding layer on the mandrels 3322, 3324, 3326, 3328 at the third station 3314, it may be desirable to increase the cooling effect of the mandrels. This can help ensure that the preforms adequately cool prior to their ejection from the cube 3320 during the subsequent fourth stage 3316. Further, even after the preforms have been ejected or otherwise removed from the mandrels at the fourth station 3316, it may be advantageous to alter the cooling effect through the mandrels in preparation for the initial injection step.

Accordingly, it may be desirable to vary the cooling effect on the mandrels 3322, 3324, 3326, 3328 throughout the molding process. For example, the flowrate and/or temperature of the cooling water or other cooling fluids delivered through the internal cooling channels 3330, 3334, 3340, 3344 of the mandrels and/or the cavity sections can be varied. Such variations can be based on the particular station or stage of the molding process in which a mandrel or set of mandrels is situated. In other embodiments, the cooling effect of the mandrels can be based, at least in part, on the size, thickness, dimensions, shape, materials, overmolding materials (e.g., PET, RPET, etc.) used and/or other characteristics of the preforms or other items being molded. For example, it may desirable to increase the cooling effect of the mandrel when thicker preforms are being produced.

In some embodiments, in order to provide individualized cooling to the mandrels 3322, 3324, 3326, 3328 positioned on different surfaces of a cube 3320, a rotary union and/or some other type of specially designed cooling system can be used.

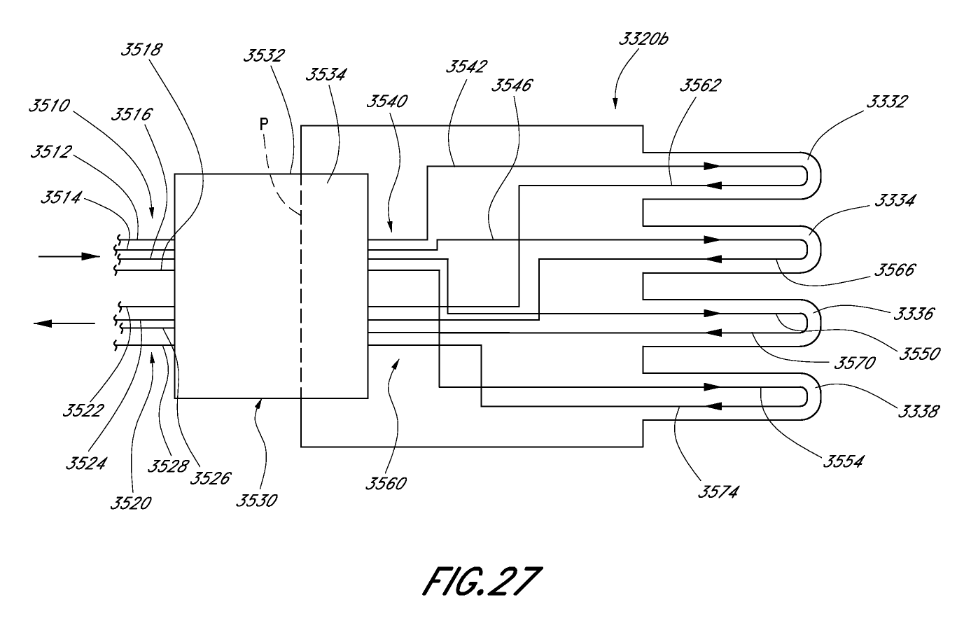

FIG. 26 schematically illustrates one embodiment of a cube 3320a comprising a rotary union 3430. The rotary union 3430 can be configured to receive one or more inlets and/or outlets for cooling water or other fluid being delivered to the mandrels. In some arrangements, the rotary union 3430 permits the cooling water or other fluid to be delivered to a cooling water distribution system 3440, 3460 located within the cube 3320a, while the cube 3320a is being indexed or rotated between the various stations 3310, 3312, 3314, 3316 of the molding system 3300. In some embodiments, as illustrated in FIG. 26, the rotary union 3430 includes a stationary portion 3432 and an adjacent movable portion 3434 which is in fluid communication with the stationary portion 3432. Thus, as the cube 3320a is rotated along line P, the cooling water or other fluid can be continuously delivered to or removed from the mandrels. Consequently, the desired cooling effect of each mandrel can be advantageously controlled.

With continued reference to FIG. 26, all the mandrels 3332, 3334, 3336, 3338 positioned on a cube 3320a can be configured to receive cooling water or other cooling fluid from a single source. As illustrated, cooling water or other fluid entering the cube 3320a from the rotary union 3430 can be routed to a single inlet header 3440. The cooling water or other fluid can then be distributed to individual inlet branches 3442, 3446, 3450, 3454. Consequently, such individual inlet branches can deliver the cooling water or other fluid to the distal ends and/or any other portion or area of the mandrels or cores. Thus, a desired cooling effect can be provided along the exterior surfaces of the cores.

With continued reference to FIG. 26, cooling water can be removed from the distal ends of the mandrels through individual outlet branches 3462, 3466, 3470, 3474 that are in fluid communication with the inlet branches 3442, 3446, 3450, 3454. The cooling water or other fluid leaving the mandrels 3332, 3334, 3336, 3338 can be collected in a single outlet header 3460 which is connected to the rotary union 3430 or other specialty fitting or device.

As illustrated in FIG. 26, one or more of the individual inlet branches 3442, 3446, 3450, 3454 can comprise a valve 3444, 3448, 3452, 3456 or other flow or temperature regulating device. This can permit individualized cooling control of the various mandrels of the cube 3320a. In some embodiments, the valves are remotely controlled to permit the temperature of the mandrels to be selectively regulated. In some embodiments, the use of pressure-reducing valves on the individualized inlet branches can further regulate the cooling effect of the mandrels, especially when a refrigerant (carbon dioxide, nitrogen, other cryogenic refrigerant, etc.) is used.

FIG. 27 schematically illustrates another embodiment of a cube 3320b comprising a rotary union 3530. As shown, the mandrels 3332, 3334, 3336, 3338 positioned on each surface of the cube 3320b can comprise separate cooling inlet 3510, 3540 and outlet 3520, 3560 lines. These individual inlet and outlet cooling lines 3510, 3540, 3520, 3560 can be connected to the stationary portion 3532 of the rotary union 3530 in the manner illustrated in FIG. 27. The rotary union 3530 can advantageously permit each side of the cube 3320b to receive the appropriate inlet and/or cooling line. For example, inlet line 3512, which is intended to be delivered to mandrel 3332, is in fluid communication with an inlet line 3542 within the cube 3320b. Further, the corresponding outlet line 3562 within the cube 3320b is in fluid communication with an outlet line 3522 outside the cube 3320b.

As a result, the cooling water or other fluids directed to or near each mandrel or set of mandrels in the cube 3320b can be advantageously customized (e.g., type, temperature, flowrate, etc.). For example, the cooling water or other fluid delivered to or near each mandrel can vary in type, temperature, flowrate, pressure and/or any other property. Consequently, molding systems which comprise such rotary union devices and fluid distribution arrangements can provide customized cooling to each side of a rotating cube 3320.

As discussed above in relation to the embodiment illustrated in FIGURE 24, such systems can be used to control the temperature of mandrels, and thus the preforms situated thereon, at the various stations 3310, 3312, 3314, 3316 of a molding system 3300. For example, the cooling effect of the mandrels at the first station 3310 can be increased to de-mold the initial layer of molten material. Further, the cooling effect of the mandrels at the second station 3312 can be decreased or completely eliminated in preparation for the subsequent overmolding stage. This permits the outside temperature of the preforms to be at the desired temperature during the overmolding injection, ensuring proper adhesion between the two adjacent preform layers. This can be accomplished by varying the flowrate, temperature, type of coolant and/or one or more other properties of the cooling water or other fluid as discussed herein.

By using the features of the embodiments of the molding system 3300 disclosed herein, the temperature of the mandrels in the second station 3312 can be optimized to allow further cooling of the melt internally while allowing heat from the center of the perform wall to radiate outward to the surface. This can allow the melt at the overmolding station 3314, 3314A to strongly adhere to the conditioned and possibly equilibrated initial substrate. As discussed herein with reference to the embodiment of FIG. 24, a second station 3312 can also be utilized for secondary treatment, such as, for example, VCP or surface treatments prior to applying the overinjection layer.

Depending upon the perform design and wall thickness, relatively drastic temperature differences may be required from station to station of the molding system 3300. As such, high heat transfer materials can facilitate the heat transfer properties of the various mold portions. This can significantly improve the ability to modify mold temperatures as the various components (e.g., cores, cavities, etc.) are indexed from one station or step to the next. For example, as discussed, the change from station to station can comprise no cooling to as much cooling as possible. Consequently, high heat transfer materials can facilitate the process, as they are capable of handling the temperature changes in a relatively rapid manner. In addition, in some embodiments, given the relatively low heat capacity of the high heat transfer materials, cooling of the mandrel can be reduced or altogether eliminated at one or more stations of the molding system.

Accordingly, the mandrels or cores and/or the corresponding cavity sections can advantageously comprise one or more high heat transfer materials, such as, for example, AMPCOLOY® alloys, alloys comprising copper and beryllium, and the like. In addition, the mandrels can be configured to receive one or more cryogenic refrigerants through their cooling channels. In some embodiments, these cryogenic materials can be directed through pressure reducing devices (e.g., valves) to decrease their pressure prior to entering the mandrels. Additional information regarding the use of high heat transfer materials, refrigerants and/or pressure reducing devices is provided herein.

It will be appreciated that in other embodiments, the rotary union and the corresponding fluid distribution systems (both within and outside of the cube 3320) can be different than disclosed herein. For instance, in some embodiments, mandrels or cores located on two or more of the sides of cube 3320 can share the same cooling inlet and outlet system. Therefore, the cores 3322, 3326 located on opposite sides of the cube 3320 can be configured to maintain a similar or substantially similar temperature. In other embodiments, mandrels from more or fewer than two sides of the cube 3320 share the same cooling inlet and/or outlet system.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

What is claimed is:

1. An injection mold system for producing multi-layer preforms, the system comprising:
a first cavity platen comprising a plurality of first cavity sections;
a second cavity platen comprising a plurality of second cavity sections; and
a core portion having at least two core surfaces, each core surface comprising a plurality of cores;
wherein the cores are configured to mate with the first cavity sections to define a plurality of first mold cavities therebetween, each of said first mold cavities configured to receive a thermoplastic material to produce a first layer of a preform;
wherein the cores are configured to mate with the second cavity sections to define a plurality of second mold cavities therebetween, each of said second mold cavities configured to receive a thermoplastic material to produce a second layer of a preform, the second layer disposed along an exterior of the first layer;
wherein the core portion is configured to rotate between various positions so the cores sequentially align and mate with the first cavity sections and the second cavity sections; and
wherein the cores from a first core surface mate with the first cavity sections generally at a same time that the cores from a second core surface mate with the second cavity sections.

2. The mold system of claim 1, wherein the core portion comprises internal channels adapted to circulate a cooling fluid within an inner portion of each core, the internal channels being configured so that a cooling effect produced at the cores of the first core surface can be selectively varied from a cooling effect produced at the cores of the second core surface.

3. The mold system of claim 2, wherein cooling fluids are configured to continue flowing through the internal channels when the core portion is being rotated.

4. The mold system of claim 2, wherein the internal channels of the core portion are in fluid communication with a rotary union.

5. The mold system of claim 1, wherein the core portion comprises a cube shape, the first core surface of the core portion being generally opposite of the second core surface.

6. The mold system of claim 1, wherein the core portion includes four core surfaces, each of said four core surfaces comprising a plurality of cores.

7. The mold system of claim 1, further comprising a treatment portion located at an intermediate treatment location, the treatment portion being adapted to selectively surface treat the preforms, wherein the core portion is configured to move to the intermediate treatment location before the cores mate with the second cavity sections.

8. The mold system of claim 7, wherein surface treatment occurring at the intermediate treatment location comprises at least one of the following: flame treatment, corona treatment, ionized air treatment, plasma arc treatment and surface abrasion.

9. The mold system of claim 1, wherein the system further comprises a robot configured to remove the multi-layer preforms from a desired set of cores.

10. The mold system of claim 1, wherein at least one of the cores, the first cavity sections and the second cavity sections comprise a high heat transfer material.

11. A method of producing multi-layer plastic objects, the method comprising:
providing a mold system, the mold system comprising:
a plurality of first cavity sections;
a plurality of second cavity sections; and
a core portion having at a first core surface and a second core surface, each of said first and second core surfaces comprising a plurality of cores, the core portion being configured to be indexed between different positions allowing the cores to sequentially mate with the first cavity sections and the second cavity sections;
indexing the core portion to a first position wherein the cores of the first core surface mate with the first cavity sections to define a plurality of first mold cavities therebetween, and wherein the cores of the second core surface mate with the second cavity sections to define a plurality of second mold cavities therebetween;
injecting a first moldable material within the first mold cavities to form a first layer of multi-layer plastic objects, and generally simultaneously injecting a second moldable material within the second mold cavities to form a second, outer layer on the plastic objects;
removing the plastic objects from the cores of the second core surface;
indexing the core portion to a second position wherein the cores of the first core surface mate with the second cavity sections and the cores of the second core surface mate with the first cavity sections;
injecting a first moldable material along the outside of the cores of the second core surface, and generally simultaneously injecting a second moldable material along the outside of the cores of the first core surface to produce a plurality of multi-layer plastic objects thereon;
removing the plastic objects from the cores of the first core surface; and
repeating the process by indexing the core portion to the first position so that the cores of the first core surface re-mate with the first cavity sections and the cores of the second core surface re-mate with the second cavity sections.

12. The method of claim 11, wherein the plastic objects comprise preforms.

13. The method of claim 11, further comprising surface treating the plastic objects prior to injecting the second moldable material thereon.

14. The method of claim 13, wherein surface treating comprises indexing the core portion to a first intermediate position, the first intermediate position located generally between the first and second positions.

15. The method of claim 13, wherein surface treating comprises at least one of the following: flame treatment, corona treatment, ionized air treatment, plasma arc treatment and surface abrasion.

16. The method of claim 11, wherein the mold system further comprises a robot having a grasping portion, wherein removing the multi-layer objects from the cores comprises:
aligning the grasping portion of the robot with the cores to engage and removably retain the multi-layer objects molded thereon.

17. The method of claim 11, wherein removing the removing the plastic objects from the cores comprises indexing the core portion to an ejection location.

18. The method of claim 11, wherein the core portion comprises internal channels adapted to circulate a cooling fluid within an inner portion of each core, the internal channels being configured so that a cooling effect produced at the cores of the first core surface can be selectively varied from a cooling effect produced at the cores of the second core surface.

19. A mold comprising:
a plurality of first cavity sections;
a plurality of second cavity sections; and
a core portion having a plurality of cores on at least a first core surface and a second core surface, the core portion configured to move so the cores on a first core surface selectively engage the first cavity sections or the second cavity sections;
wherein the core portion comprises internal channels adapted to circulate a cooling fluid within an inner portion of each core, the internal channels being configured so that a cooling effect produced at the cores of the first core surface can be selectively varied from a cooling effect produced at the cores of the second core surface.

20. The mold of claim 19, wherein cooling fluids are configured to continue flowing through the internal channels when the core portion is being rotated.

21. The mold of claim 19, wherein the internal channels of the core portion are in fluid communication with a rotary union.

22. The mold of claim 19, wherein internal channels within an inner portion of the cores positioned along the first core surface are in fluid communication with a first fluid source, and wherein internal channels within an inner portion of the cores positioned along the second core surface are in fluid communication with a second fluid source.

23. The mold of claim 19, wherein at least one of the cores, the first cavity sections and the second cavity sections comprise a high heat transfer material.
